(19) United States
(12) Patent Application Publication
(10) Pub. No.: US 2026/0210034 A1
(43) Pub. Date: Jul. 23, 2026

(54) Catechol Polymer Coatings for High-Performance Polymeric Fiber Surface Functionalization

(71) Applicant: Mussel Polymers, Inc., Bethlehem, PA (US)

(72) Inventor: Jason Stieg, Lafayette Hill, PA (US)

(21) Appl. No.: 19/107,783

(22) PCT Filed: Sep. 1, 2023
(86) PCT No.: PCT/US2023/073346

§ 371 Date: Feb. 28, 2025

Related U.S. Application Data
(60) Provisional application No. 63/403,237, filed on Sep. 1, 2022.

(51) Int. Cl. D06M 15/233; C08J 5/06; C08J 5/24; C08J 7/04; C08J 7/043; C09D 5/00; C09D 7/61; C09D 125/18; D06M 101/36; D06M 101/40

(52) U.S. Cl. CPC D06M 15/233; C08J 5/06; C08J 5/248; C08J 7/042; C08J 7/043; C09D 5/002; C09D 7/61; C09D 125/18; C08J 2323/06; C08J 2323/12; C08J 2325/18; C08J 2327/18; C08J 2361/06; C08J 2363/00; C08J 2367/00; C08J 2371/10; C08J 2375/04; C08J 2377/00; C08J 2379/04; C08J 2379/08; D06M 2101/36; D06M 2101/40; D06M 2200/40

(57) ABSTRACT

This disclosure relates to high-performance fibers (HPF), fiber-reinforced composites, plastics, and other materials. This disclosure also relates to HPF fibers coated with materials containing catechol polymers, more specifically polycatechol styrene (PCS). This disclosure also relates to the process of functionalizing the HPF fiber surfaces using the PCS-type coatings. In some embodiments, the fibers are polymeric materials such as aramids, liquid-crystalline polymers (LCP), and ultra-high molecular-weight polyethylene (UHMWPE). In one embodiment, the HPF are carbon fibers.

### CROSS REFERENCE TO RELATED APPLICATIONS

This application claims the benefit of U.S. Provisional Application No. 63/403,237, filed Sep. 1, 2022, the entirety of which is incorporated by reference herein.

### FIELD OF INVENTION

This disclosure relates to high-performance fibers (HPF), fiber-reinforced composites, plastics, and other materials. This disclosure also relates to HPF fibers coated with materials containing catechol polymers, more specifically polycatechol styrene (PCS). This disclosure also relates to the process of functionalizing the HPF fiber surfaces using the PCS-type coatings. In some embodiments, the fibers are polymeric materials such as aramids, liquid-crystalline polymers (LCP), and ultra-high molecular-weight polyethylene (UHMWPE). In one embodiment, the HPF are carbon fibers.

### BACKGROUND

High-performance fiber (HPF) such as high-performance polymeric fiber (HPP fiber) is a very important reinforcing fiber for thermoset, thermoplastic, and other composite materials. While HPP fiber-reinforced plastics (FRP) could be outstanding materials for many applications across a range of industries due to their high-specific modulus, specific strength, and corrosion resistance, due to the inert polymeric structure on the surface of the HPP fiber, the interfacial adhesion between the fiber and matrix can be weak and many HPP-FRP exhibit a tendency to fail at the fiber-matrix interface. This phenomenon can greatly affect the overall mechanical properties of the composites such as flexural performance, interlaminar shear strength (ILSS), and others. Good interfacial adhesion can effectively transfer stress from the matrix to the reinforcement, which promotes the dispersion of the stress and increases the mechanical strength of the composite.

Similarly, an HPF such as carbon fiber (CF) is a very important reinforcing fiber for thermoset, thermoplastic and other composite materials (CFRP). CFRP are outstanding materials for many applications across a range of industries due to their high-specific modulus, specific strength, and corrosion resistance. However, due to the inert graphite structure on the surface of CF, the interfacial adhesion between the fiber and matrix tend to be weak and most CFRP exhibit a tendency to fail also at the fiber-matrix interface. This phenomenon can greatly affect the overall mechanical properties of the composites such as flexural performance, interlaminar shear strength (ILSS), and others. Similar to HPP, in CF too, good interfacial adhesion can effectively transfer stress from the matrix to the reinforcement, which promotes the dispersion of stress and increases the mechanical strength of the composite.

In recent years, many methods to improve the interfacial adhesion of fibrous material to composite matrices have been proposed, such as chemical grafting, sizing, carbon black, electrophoretic deposition, and introducing nanoparticles. However, many of these processes are extremely toxic, consume large amounts of energy, and are carried out in harsh conditions which can damage the fibers themselves. This has limited the development of these processes for industrial applications. It would be of great utility to develop an effective, safe, and environmentally friendly process for improving the interfacial properties of HPF such as HPP fibers for the development of high performance HPP-FRPs and CFs for the development of high performance CFRPs.

One method for improving the interfacial shear strength of fibers to matrix materials is by altering the surface “roughness” and thus the surface energy of the fibers. For example, for carbon fibers, depositing or coating of carbonaceous materials such as carbon nanotubes, carbon nanofibers, graphene, and carbon black. This method does not chemically functionalize the surface of the CF, but rather alters the surface “roughness” and thus the surface energy of the fibers. These carbonaceous materials are deposited through several methods, which can be expensive, hazardous, or both. These methods include Chemical Vapor Deposition, Spray Coating and Dip Coating.

### SUMMARY OF INVENTION

The present disclosure, on the other hand, provides a polycatechol styrene based coating on the HPF such as HPP fiber and CF rendering it as an effective adhesion promoter, which can then be incorporated into various composite materials. Such coatings would also be effective not simply at smaller scales in a laboratory environment, but also for larger scale industrial and commercial applications.

In one embodiment, this disclosure relates to a coated high-performance fiber (HPF) coated with a catechol-containing material on the HPF, comprising a polymer containing catechol, semi-quinone, or quinone.

In another embodiment, this disclosure relates to the coated HPF as recited above, wherein the catechol-containing material coated on the HPF comprises monomeric, oligomeric, or polymeric catechol or catechol-containing material, wherein said catechol presents as a catechol and/or as a semi-quinone and/or as a quinone without the presence of an amine; and wherein the polymeric layer optionally comprises at least one of: a) a reactive species separate from the catechol or catechol-containing material; and b) a catalyst, co-catalyst or an accelerator.

In yet another embodiment, this disclosure relates to the coated HPF as recited above, wherein the polymeric material comprises the reactive species separate from the catechol-containing polymer or oligomer; and the reactive species is a urethane component, an epoxy resin, an acrylate monomer or oligomer, a methacrylate monomer or oligomer, a silane, or a combination thereof.

In one embodiment, this disclosure relates to the coated HPF as recited above, wherein the reactive species is:
(i) a urethane component;
(ii) a urethane component that is a polyol or an organic compound containing multiple hydroxyl groups, and wherein the urethane is linear or branched;
(iii) a urethane component that is 1,6-hexanediol, glycerol, Stepanpol PDC-279® or poly caprolactone triol;
(iv) an epoxy resin;
(v) an epoxy resin that is an epoxy monomer, an epoxy oligomer, a poly epoxide or combinations thereof; and wherein the epoxy is linear or branched;
(vi) an epoxy resin that is bisphenol A diglycidyl ether, Bisphenol A epoxy resin, bis(4-glycidyloxyphenyl)methane, bisphenol E diglycidyl ether (DGEBE), 2,2′-[I,I-Ethanediylbis(4,I-phenyleneoxymethylene)]dioxirane, bisphenol F diglycidyl ether (DGEBF), poly(bisphenol A-co-epichlorohydrin) or combinations thereof;
(vii) an acrylate monomer or oligomer;
(viii) an acrylate monomer or oligomer that is an acrylate monomer comprising a vinyl group and at least one of a carboxylic acid ester and a carboxylic acid nitrile; and wherein the acrylate is linear or branched; or
(ix) an acrylate monomer or oligomer that is ethyl acrylate, ethylene-methyl acrylate, methyl methacrylate, 2-chloroethyl vinyl ether, 2-hydroxyethyl acrylate, hydroxyethyl methacrylate, butyl acrylate, trimethylolpropane triacrylate (TMPTA) or combinations thereof.

In another embodiment, this disclosure relates to the coated HPF as recited above, wherein the polymeric layer comprises the catalyst, co-catalyst or accelerator; and the catalyst, co-catalyst or accelerator is a urethane catalyst that promotes a urethane polymerization reaction, an epoxy catalyst that promotes an epoxy polymerization reaction, an acrylate catalyst that promotes an acrylate polymerization reaction, or combinations thereof.

In yet another embodiment, this disclosure relates to the coated HPF as recited above, wherein the catalyst, co-catalyst or accelerator is:
(i) a urethane catalyst that promotes a urethane polymerization reaction;
(ii) a urethane catalyst that promotes a urethane polymerization reaction that is 1,4-diazabicyclo[2.2.2]octane, K-KAT 6212, benzyldimethylamine or combinations thereof;
(iii) an epoxy catalyst that promotes epoxy polymerization;
(iv) an epoxy catalyst that is 1,4-diazabicyclo[2.2.2]octane;
(v) an acrylate catalyst that promotes acrylate polymerization; or
(vi) an acrylate catalyst that is an acrylic or a free-radical polymerization promoter.

In one embodiment, this disclosure relates to the coated HPF as recited above, wherein the coating of the polymeric material has a thickness:
(i) of from about 5 nanometers to about 100 microns;
(ii) of from about 15 nanometers to about 50 microns;
(iii) of from about 15 nanometers to about 15 microns;
(iv) of from about 50 nanometers to less than about 15 microns; or
(v) of from about 50 nanometers to about 1.5 microns.

In another embodiment, this disclosure relates to the coated HPF as recited above, wherein the catechol-containing polymer or oligomer comprises poly-catechol styrene (PCS).

In yet another embodiment, this disclosure relates to the coated HPF as recited above, wherein the molecular weight is in the range of 100 to 1,000,000.

In one embodiment, this disclosure relates to the coated HPF as recited above, wherein the PCS comprises from about 15% catechol to about 85% catechol.

In another embodiment, this disclosure relates to the coated HPF as recited above, wherein the PCS comprises about 25% catechol or about 35% catechol.

In yet another embodiment, this disclosure relates to the coated HPF as recited above, wherein the HPF is a polymer.

In one embodiment, this disclosure relates to the coated HPF as recited above, wherein the HPF is an aramid, a super-aramid, an aramid copolymer, a meta-aramid, an LCP, the UHMWPE polymer, a polyamide, a polyester, a polyolefin, or a combination thereof.

In another embodiment, this disclosure relates to the coated HPF as recited above, wherein the HPF is a carbon fiber.

In yet another embodiment, this disclosure relates to a fiber-reinforced composite comprising one or more HPF as recited above.

In one embodiment, this disclosure relates to the fiber-reinforced composite as recited above, wherein the matrix polymer is selected from:

Polypropylene, Polyethylene, Polycarbonate, Polyvinyl Chloride, Polyetheretherketone, Polyethersulfone, Polyphenylene Sulfide, Polyamide, Polymethyl Methacrylate, Polyetherimide, Acetal, Sulfone Polymers, Ethylene-Vinyl Acetate, Liquid Crystal Polymers, Polybutylene Terephthalate, Acrylonitrile Butadiene Styrene, Fluoropolymers, Thermoplastic Elastomers, Thermoplastic Polyurethane, Polycyclohexylenedimethylene Terephthalate, Epoxy Resins, Polyester Resins, Vinyl Ester Resins, Phenolic Resins, Polyimides, Polyurethane, Polystyrene, Silicone Resins, Cyanate Esters, Melamine-Formaldehyde Resins, Polydicyclopentadiene, Polyarylate, Polybenzimidazole, Polychlorotrifluoroethylene, Methyl Methacrylate-Butadiene-Styrene, Polyacrylonitrile, Polyhydroxyalkanoates, Polylactic Acid, Polyhydroxybutarate, Polyoxymethylene copolymer.

In another embodiment, this disclosure relates to a method for preparing the HPF as recited above, said method comprising exposing HPF to pre-polymerized catechol-containing polymers dissolved in one or more solvents.

In yet another embodiment, this disclosure relates to the method for functionalizing the surface of the HPF surface as recited above, comprising exposing the HPF to pre-polymerized catechol-containing polymers dissolved in one or more solvents.

In one embodiment, this disclosure relates to the coated HPF as recited above, wherein the HPF are fully or partially covered with material comprising PCS polymer.

In another embodiment, this disclosure relates to an article of manufacture comprising the fiber reinforced composite as recited in above.

In yet another embodiment, this disclosure relates to a method for applying a coating to at least one face of a substrate made of the fiber-reinforced composite as recited above, wherein the method comprises:
applying a PCS layer filled with particles of graphene or of zinc to the at least one face of the substrate as a primer, and
applying a coating to the zinc or graphene particle-filled PCS layer.

In one embodiment, this disclosure relates to a method as recited above, wherein:
the zinc or graphene particle-filled adhesive PCS layer has a thickness of between 200 nm and 100 μm; and/or
the PCS layer is filled with graphene particles and comprises 0.5% to 2% by weight of graphene.

In another embodiment, this disclosure relates to a substrate comprising, on at least one face a coating applied by implementing the method as recited above.

In yet another embodiment, this disclosure relates to an aircraft part comprising the substrate as recited above.

### BRIEF DESCRIPTION OF DRAWINGS

FIGS. 1A and 1B depict a high-performance fiber (HPF) that is coated with at least one layer of catechol-containing materials, and other optional layers including one or more catechol-containing layers.

FIG. 2 depicts SEM micrographs of aramid fibers without any coating treatment (2A, 2D, 2G); aramid fibers with a 6% ZnCl₂ bath (2B, 2E, 2H); and aramid fibers treated in a ZnCl₂ bath and PCS coating (2C, 2F, 2I).

FIG. 3 depicts SEM images of carbon fiber (CF) coated with poly-catechol styrene (PCS): FIGS. 3A, 3B, and 3C correspond to magnification of 7K×, 2×, and 700×, respectively.

FIG. 4 shows SEM images for both untreated Teijin Tenax chopped carbon fibers, and PCS-coated chopped carbon fibers: SEM micrographs of carbon fibers without any coating treatment (4A, 4C, 4E) or with a PCS coating (4B, 4D, 4F).

FIG. 5 depicts SEM micrographs of recycled carbon fibers coated with PCS: FIG. 5. (5A, 5C) are recycled carbon fibers that have been cleaned with acetone, and Fig. (5B, 5D) are recycled carbon fibers that have been treated with a poly(catechol-styrene) (PCS) coating.

FIG. 6 depicts SEM micrographs of poly(catechol-styrene) (PCS)-coated recycled carbon fibers: Figs. (6A, 6C) relate to fibers in which a 0.5% PCS solution is used to coat the carbon fibers; and Figs. (5B, 5D) relate to a 3% PCS solution used to coat the carbon fibers, which heavily coats the fibers in a thick PCS coating.

FIG. 7 relates to the process of dip-coating carbon fibers with PCS sizing solution. The carbon fiber (FIG. 7A) was dipped in the solutions (FIGS. 7B and 7C). Air-dried samples are shown in (FIG. 7D).

FIG. 7.1 shows the FTIR Transmittance as function of Wave Numbers for the PCS polymer 240K molecular weight, same polymer as 1% concentration in acetone that is used for 5 min of dip-coating, 15 min of dip-coating, and 30 min of dip-coating.

FIGS. 7E, 7F, and 7G show as-received Chomarat® carbon fiber (0/90) that are two layers at three different magnifications. FIG. 7H shows the carbon fibers before burn-off, and FIGS. 7I and 7J are carbon fibers after burn-off. FIGS. 7K, 7L, and 7M are SEM micrographs of the carbon fiber after the furnace burn-off.

FIG. 8 shows the FTIR scan for the as-received and burnt-off carbon fibers.

FIGS. 9A, 9B, and 9C are SEMs of the as-received carbon fiber that is coated with a 0.5% PCS polymer solution in acetone that is dip-coated for 30 min. The PCS used is the 240K Dalton molecular-weight material.

FIGS. 10A, 10B, and 10C are SEMs of the as-received carbon fiber that is coated with a 1.0% PCS polymer solution in acetone that is dip-coated for 30 min. The PCS used is the 240K Dalton molecular-weight material.

FIG. 11 shows the FTIR scan for the as-received carbon fibers that were coated with 1% PCS in an acetone solvent with the dip-coating of 5, 15, and 30 min. The PCS used is the 240K Dalton molecular-weight material.

FIGS. 12A, 12B, and 12C are SEMs of the as-received carbon fiber that is coated with a 1.5% PCS polymer solution in acetone that is dip-coated for 5 min.

FIGS. 13A, 13B, and 13C are SEMs of the as-received carbon fiber that is coated with a 1.5% PCS polymer solution in acetone that is dip-coated for 15 min.

FIGS. 14A, 14B, and 14C are SEMs of the as-received carbon fiber that is coated with a 1.5% PCS polymer solution in acetone that is dip-coated for 30 min.

FIG. 15 shows the FTIR scan for the as-received carbon fibers that were coated with 1.5% PCS in an acetone solvent with the dip-coating of 5, 15, and 30 min. The PCS used is the 240K Dalton molecular-weight material.

FIGS. 16A, 16B, and 16C are SEMs of the as-received carbon fiber that is coated with a 2.0% PCS polymer solution in acetone that is dip-coated for 5 min.

FIGS. 17A, 17B, and 17C are SEMs of the as-received carbon fiber that is coated with a 2.0% PCS polymer solution in acetone that is dip-coated for 15 min.

FIGS. 18A, 18B, and 18C are SEMs of the as-received carbon fiber that is coated with a 2.0% PCS polymer solution in acetone that is dip-coated for 30 min.

FIG. 19 shows the FTIR scan for the as-received carbon fibers that were coated with 2.0% PCS in an acetone solvent with the dip-coating of 5, 15, and 30 min. The PCS used is the 240K Dalton molecular-weight material.

FIG. 20A shows the top surface of the carbon fiber after dip-coating at 5, 15, and 30 min. FIG. 20B shows the bottom surface of the carbon fiber after dip-coating at 5, 15, and 30 min.

FIG. 21 shows the carbon fiber that has been sized with PCS via dip-coating that is then used to make a laminate with PEEK matrix.

### DETAILED DESCRIPTION OF THE INVENTION

Unless otherwise defined, all technical and scientific terms used herein have the same meaning as commonly understood by one of ordinary skill in the art to which this disclosure pertains. The terminology used in the description is for describing particular embodiments only and is not intended to be limiting of the disclosure.

The following terms are used to describe the present disclosure. In instances where a term is not specifically defined herein, that term is given an art-recognized meaning by those of ordinary skill applying that term in context to its use in describing the present disclosure.

In the present disclosure the singular forms “a”, “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about” or “substantially” it will be understood that the particular value forms another embodiment. In general, use of the term “about” or “substantially” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about” or “substantially”. In other cases, the gradations used in a series of values may be used to determine the intended range available to the term “about” or “substantially” for each value. Where present, all ranges are inclusive and combinable. That is, references to values stated in ranges include every value within that range.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

It is to be appreciated that certain features of the disclosure which are, for clarity, described herein in the context of separate embodiments, may also be provided in combination in a single embodiment. That is, unless obviously incompatible or excluded, each individual embodiment is deemed to be combinable with any other embodiments and such a combination is considered to be another embodiment. Conversely, various features of the disclosure that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation. Finally, while an embodiment may be described as part of a series of steps or part of a more general structure, each said step may also be considered an independent embodiment in itself.

The following describes exemplary embodiments of the present disclosure in the high-performance fibers (HPF) context. This disclosure relates to HPF that are coated with catechol-containing materials. A preferred catechol-containing material comprises poly catechol-styrene (PCS), as described infra. While the various embodiment disclosed infra may refer to PCS or PCS-type material, it is to be understood that PCS is being used as an example for catechol-containing material. The term PCS-type is also used to denote materials that contain catechol and are similar to PCS.

In one embodiment, high-performance fibers or super fibers used for coating in the present disclosure include aromatic polyamide (aramid), for example, Kevlar™, gel-spun high modulus polyethylene (UHMWPE), super-aramids and aramid copolymers, melt-spun liquid crystal aromatic polyester (LCP), and carbon fibers.

In another embodiment, other HPP fibers used in the present disclosure include polyamides, polyolefins, and polyesters. These include commodity fibers such as Nylon 6, Nylon 6,6, which are melt-spun, high-performance aromatic polyamides, or aramids, which are acid-spun from monomers, or meta-aramids such as Nomex®, and their copolymers. Examples of polyolefins include commodity fibers from LLDPE or polypropylene, which are melt-spun, and high-performance polyethylene and polypropylene fibers, which are gel-spun. Polyester examples include commodity fibers from polyesters such as PET, PTT, and PBT, which are melt-spun, and high-performance aromatic polyester, which include arresters or liquid-crystal polymers (LCPs) and/or their copolymers.

### I. Aromatic Polyamides or ARAMIDS

Aramid fibers used for coating in the present disclosure include the ones that are heat-resistant and strong synthetic fibers with use in aerospace and military applications, for ballistic-rated body armor fabric and ballistic composites, in marine cordage, marine hull reinforcement, and as an asbestos substitute. The chain molecules in the fibers are highly oriented along the fiber axis. As a result, a higher proportion of the chemical bond contribute more to fiber strength than in many other synthetic fibers. Aramids have a very high melting point (>500° C.). Common aramid brand names include Kevlar®, Nomex®, and Twaron®. Aramids share a high degree of orientation with other fibers such as ultra-high-molecular-weight polyethylene, a characteristic that dominates their properties. Further examples of aramids include Technora® and Vectran®.

The aramids possess one or more of the following properties:
High tensile strength
High abrasion resistance
Lightweight
High resistance to chemicals good resistance to organic solvents
Excellent durability
Thermal stability
Heat/flame resistance
Low moisture absorption
Cut/slash/impact resistant
nonconductive
very high melting point (>500° C.)
good fabric integrity at elevated temperatures
sensitive to acids and salts
sensitive to ultraviolet radiation
prone to electrostatic charge build-up unless finished
para-aramid fibers, such as Kevlar® and Twaron® provide outstanding strength-to-weight properties
high chord modulus
low creep
low elongation at break (~3.5%)
difficult to dye—usually solution-dyed

The end uses of these fibers include the following:
Protective textiles & apparel/PPE
Industrial Specialty fabrics
Ropes/cables
Aerospace/military/law enforcement
Heavy lift slings/straps
Specialty electronics
Flexible composites/inflatables
flame-resistant clothing
heat-protective clothing and helmets
body armor
composite materials
asbestos replacement (e.g., brake linings)
hot air filtration fabrics
tires, newly as Sulfron® (sulfur-modified Twaron®)
mechanical rubber goods reinforcement
ropes and cables
V-belts (automotive, machinery, equipment, and more)
wicks for fire dancing
optical fiber cable systems
sail cloth
sporting goods
drumheads
wind instrument reeds
loudspeaker diaphragms
boathull material
fiber-reinforced concrete
reinforced thermoplastic pipes
tennis strings
hockey sticks
snowboards
jet engine enclosures
fishing reel drag systems.
asphalt reinforcement
Prusiks for rock climbers.

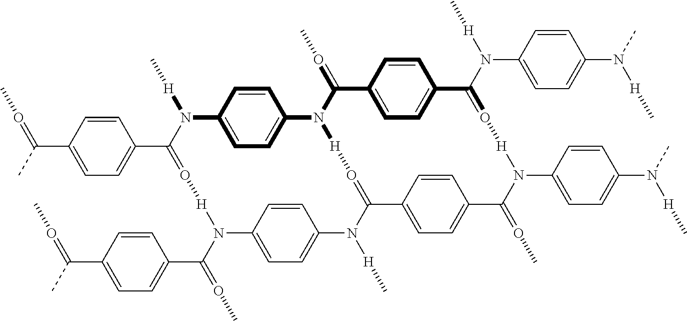

In one embodiment, the aramids of the present disclosure for PCS-type coating have a molecular structure as shown above, wherein generally, the hexagonal rings are attached alternately to either two NH groups or two CO groups. The attachment points on each ring are diametrically opposite each other, meaning this is classed as a para-aramid. In aramids the aromatic rings are connected via amide linkages each comprising a CO group attached to an NH group. Aramids are divided into two main types according to where the linkages attach to the rings. Numbering the carbon atoms sequentially around a ring, para-aramids have the linkages attached at positions 1 and 4, while meta-aramids have them at positions 1 and 3. That is, the attachment points are diametrically opposite each other in para-aramids, and two atoms apart in meta-aramids. The illustration thus shows a para-aramid.

The meta-aramid fiber Nomex® used for PCS-type coating in the present disclosure is characterized by its excellent resistance to heat, as it neither melts nor ignites in normal levels of oxygen. It is used extensively in the production of protective apparel, air filtration, thermal and electrical insulation, as well as a substitute for asbestos. Meta-aramids include Teijinconex®, Arawin®, New Star®, X-Fiper® and a variant of meta-aramid Kermel®.

Para-aramid fiber used for PCS-type coating in the present disclosure includes Kevlar®, Twaron®, Heracron®, and Taparan®. Para-aramids are used in many high-tech applications, such as aerospace and military applications, for “bullet-proof” body armor fabric. Both meta-aramid and para-aramid fiber can be used to make aramid paper. Aramid paper is used as electrical insulation materials and construction materials to make honeycomb core. Aramid papers include meta-aramid and para-aramid paper, for example, Nomex® paper and Metastar® paper. The aramid fibers can be rendered into fiber, chopped fiber, powder, or pulp.

Besides meta-aramids like Nomex®, other variations used for PCS-type coating in the present disclosure belong to the aramid fiber range. These are mainly of the copolyamide type, best known under the brand name Technora®.

### II. Liquid Crystal Polymer (LCP) Fibers

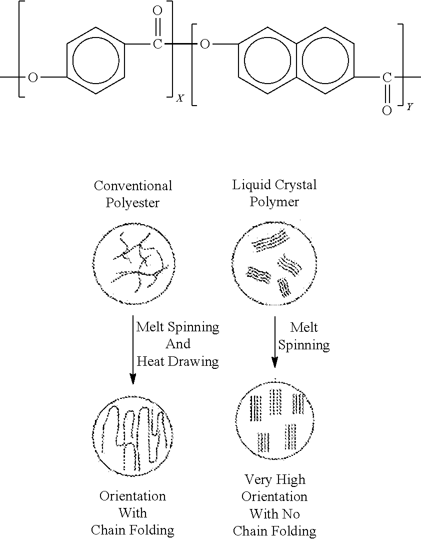

### Molecular and Crystal Orientation in Spun Polymers

For use for PCS-type coating in the present disclosure, in one embodiment, an LCP based on p-hydroxybenzoic acid (HBA) and 2-hydroxy-6-naphthoic acid (HNA) HBA/HNA copolymer, which has been used for the production of Vectran® HT LCP fiber can be used. When liquid crystal polymers are spun into fibers, some alignment of the crystal domains occurs, as shown schematically above. Some alignment to the spinning direction also occurs in amorphous polymers such as PET, but in LCP's the aligned crystal domains leads to much higher tensile properties such as strength and modulus.

Polyester-based LCP fibers used for PCS-type coating in the present disclosure can reach tenacities in excess of 3.5 GPa (>28 gpd) with <4% elongation at failure. The primary advantages of LCP over competitive high-performance fibers include dimensional and property stability over a wide range of temperatures, and long service life due to enhanced durability against repeated abrasion, flex-fatigue, and chemical exposure. This class of fibers has found increasing use in demanding aerospace, military, and industrial applications across a wide range of environments.

Specific applications for LCP fibers used for PCS-type coating in the present disclosure include low-creep ropes, multi-component cables and umbilicals, and technical fabrics. Flexible composites using coated Vectran® fabrics are used in many technical end uses such as rapidly deployable inflatable structures, lighter-than-air craft, and air-supported tension members. LCP fibers are used in applications similar to UHMWPE (ultra-high molecular-weight polyethylene) and aramid fiber. For example, while rope handlers in the heavy marine environment favor lighter weight UHMWPE fibers, LCP fibers are used in elevated temperatures, which can create dimensional instability in UHMWPE. In cables and coated fabrics, the near-zero moisture content of LCP eliminates fiber outgassing that can cause blistering of polymer coatings or jackets during extrusion. In industrial fabrics, the improved flex-fold and abrasion resistance of LCP compared with aramid reduces premature fatigue failures in coated fabrics and personal protective equipment.

LCPs are categorized by the location of liquid crystal cores. Main chain liquid crystal polymers (MCLCPs) have liquid crystal cores in the main chain. Side chain liquid crystal polymers (SCLCPs) have pendant side chains containing the liquid crystal cores. Main chain LCPs have rigid, rod-like mesogens in the polymer backbones, which indirectly leads to the high melting temperature of this kind of LCPs. In side chain LCPs, the mesogens are in the polymer side chains. The mesogens usually are linked to the backbones through flexible spacers.

Mesogens in LCPs can self-organize to form liquid crystal regions in different conditions. Based on the mechanism of aggregation and ordering, LCPs can be roughly divided into two subcategories: Lyotropic systems and Thermotropic systems.

Lyotropic main chain LCPs have rigid mesogen cores (like aromatic rings) in the backbones. Lyotropic main chain LCPs have been mainly used to generate high-strength fibers such as Kevlar. Lyotropic side chain LCPs like alkyl polyoxyethylene surfactants attached to polysiloxane polymers may be applied to personal care products like liquid soap, and the like.

The thermotropic LCPs can be processed when the melting temperature is far below the decomposition temperature. Above the melting temperature and glass transition temperature and below the clearing point, the thermotropic LCPs will form liquid crystals. There are other systems like phototropic systems.

This disclosure also relates to methods for coating the above HPF with catechol-containing materials.

### III. Carbon Fibers

Carbon fibers are lightweight and excellent in strength and elastic modulus, and thus are combined with various matrix resins to form composite materials, which are used in various fields including aircraft members, spacecraft members, automobile members, ship members, constructional materials, and sporting goods. In order to impart excellent characteristics of carbon fibers to a composite material including the carbon fibers, excellent adhesion between the carbon fibers and a matrix resin is important.

In order to improve the adhesion between carbon fibers and a matrix resin, the carbon fibers are typically subjected to oxidation such as gas phase oxidation and liquid phase oxidation, and thus oxygen-containing functional groups are introduced to the surface of the carbon fibers. For example, a disclosed method includes subjecting carbon fibers to electrolysis to improve interlaminar shear strength as an index of the adhesion. However, as a composite material has been required to have higher characteristics in recent years, the adhesion achieved by such an oxidation alone is becoming insufficient.

Carbon fibers are brittle and poor in bindability and abrasion resistance and thus readily generate fluffs or broken threads in a high-order processing step. To address this issue, methods of coating carbon fibers have been disclosed.

In one embodiment, this disclosure relates to individual and plurality of carbon fibers that are coated with a thin poly(catechol-styrene) (PCS) film. This thin polymer film functionalizes the previously inert carbon fiber surface with catechol moieties that can aid in adhesion to the matrix of various thermoset, thermoplastic and other composite materials. The method of coating comprises stirring raw carbon fibers in an organic solvent with dissolved PCS. The PCS from in the solution forms bonds with the carbon fiber surface leaving a thin film deposited on it. Following this coating reaction, the fibers are filtered, rinsed with isopropyl alcohol and DI water, and dried, preferably in a vacuum chamber to remove any residual solvent.

This one-step coating process is advantageous to many other coating processes. In one embodiment, the advantage of PCS is that it is pre-polymerized, so in one embodiment of the coating process the pre-formed catechol-containing polymer interacts with the carbon fiber surface.

The carbon fiber can be chopped strands and may be any of PAN type, pitch type and others and are not limited in their starting materials and in their production method. The length of the carbon fiber chopped strands is not critical, but in one embodiment, it is 5 microns to 50 mm. The diameter and the number of filaments which constitute the carbon fiber chopped strand are also not critical, but in one embodiment, the diameter is usually 500 nm-50 micron. and the number of the filaments is usually 100-100,000. The carbon fiber chopped strands may be previously applied with a sizing agent.

### IV. Coating of Catechol-Containing Materials on High-Performance Fibers

The high-performance fibers (HPF) described above can be coated with at least one layer comprising catechol-containing materials such as PCS, as described below.

In an aspect, the disclosure is directed to an HPF coated with a catechol-containing material such as PCS comprising a catechol-containing polymer or oligomer, wherein said catechol presents as a catechol and/or as a semi-quinone and/or as a quinone without the presence of a primary amine or a secondary amine; and wherein the polymeric material optionally comprises at least one of: a) a reactive species separate from the catechol-containing polymer or oligomer; and b) a catalyst, co-catalyst or an accelerator.

In some embodiments, the catechol-containing material coated on the HPF comprises the catechol-containing polymer or oligomer, wherein said catechol presents as a catechol and/or as a semi-quinone and/or as a quinone without the presence of a primary amine or a secondary amine.

In some embodiments, the catechol-containing material coated on the HPF comprises the catechol-containing polymer or oligomer, wherein said catechol presents as a catechol and/or as a semi-quinone and/or as a quinone without the presence of a primary amine or a secondary amine; and also comprises the reactive species separate from the catechol-containing polymer or oligomer.

In some embodiments, the catechol-containing material coated on the HPF comprises the catechol-containing polymer or oligomer, wherein said catechol presents as a catechol and/or as a semi-quinone and/or as a quinone without the presence of a primary amine or a secondary amine; and also comprises the catalyst, co-catalyst or an accelerator.

In some embodiments, the catechol-containing material coated on the HPF comprises the catechol-containing polymer or oligomer, wherein said catechol presents as a catechol and/or as a semi-quinone and/or as a quinone without the presence of a primary amine or a secondary amine; and also comprises both the reactive species separate from the catechol-containing polymer or oligomer and the catalyst, co-catalyst or an accelerator.

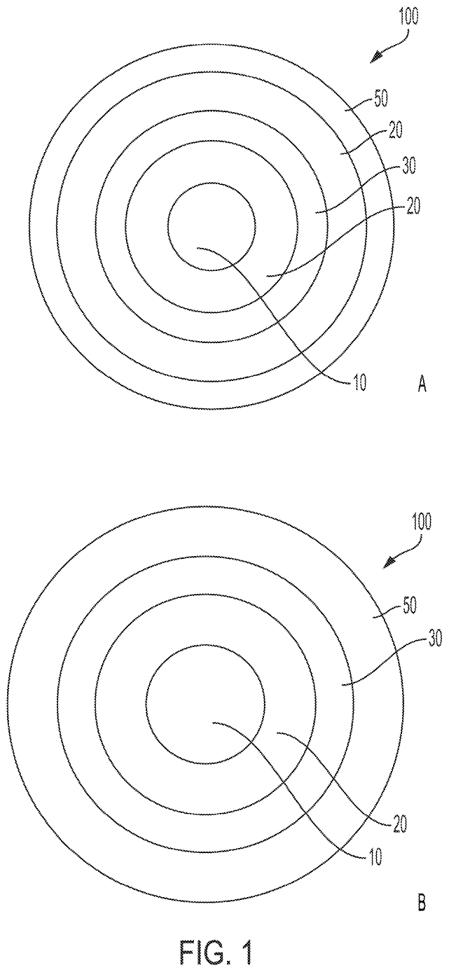

FIG. 1 depicts a general schematic of the catechol-containing material 20 coated on the HPF 20 comprising the catechol-containing polymer or oligomer and a layered HPF 100 comprising the catechol-containing material described herein. The coated HPF 100 comprises an HPF core 10 and the catechol-containing material 20 coated on the HPF 10.

The coated HPF 100 may also optionally comprise another polymer 30 disposed on the catechol-containing material coated on the HPF 20 and in contact with the catechol-containing material coated on the HPF 20. The coated HPF 100 may also comprise a second catechol-containing material coated on the HPF comprising the catechol-containing polymer or oligomer 40 disposed on and in contact with polymer 30. In one embodiment, the coated HPF 100 may also comprise a second polymer layer 50 disposed on and in contact with the second catechol-containing material coated on the HPF 40. The polymer 30 or the second polymer 50 can be a catechol-containing polymer or oligomer, or another polymer.

In some embodiments, the catechol-containing polymer or oligomer in the catechol-containing material coated on the HPF 20 is oligomeric. In some embodiments, the catechol-containing polymer or oligomer in the catechol-containing material coated on the HPF 20 is polymeric.

In an aspect, the catechol-containing material coated on the HPF 20 comprises the reactive species separate from the catechol-containing polymer or oligomer. In an aspect, the reactive species is a urethane component, an epoxy resin, an acrylate monomer or oligomer, a methacrylate monomer or oligomer, a silane, or a combination thereof.

In some embodiments, the reactive species separate from the catechol-containing polymer or oligomer is a urethane component. In some embodiments, the urethane component is a polyol or an organic compound containing multiple hydroxyl groups; and wherein the urethane is linear or branched.

In some embodiments, the urethane component is 1,6-hexanediol, glycerol, Stepanpol PDC-279® or polycaprolactone triol. In some embodiments, the urethane component is 1,6-hexanediol. In some embodiments, the urethane component is glycerol. In some embodiments, the urethane component is Stepanpol PDC-279®. In some embodiments, the urethane component is polycaprolactone triol.

In an aspect, the reactive species separate from the catechol-containing polymer or oligomer is an epoxy resin. In some embodiments, the epoxy resin is an epoxy monomer, an epoxy oligomer, a polyepoxide or combinations thereof and wherein the epoxy is linear or branched. In some embodiments, the epoxy resin is an epoxy monomer. In some embodiments, the epoxy resin is an epoxy oligomer. In some embodiments, the epoxy resin is a polyepoxide.

In some embodiments, the epoxy resin is bisphenol A diglycidyl ether, Bisphenol A epoxy resin, bis(4-glycidyloxyphenyl)methane, bisphenol E diglycidyl ether (DGEBE), 2,2′-[1,1-Ethanediylbis(4,1-phenyleneoxymethylene)]dioxirane, bisphenol F diglycidyl ether (DGEBF), poly(bisphenol A-co-epichlorohydrin) or combinations thereof.

In some embodiments, the epoxy resin is bisphenol A diglycidyl. In some embodiments, the epoxy resin is bisphenol A epoxy resin. In some embodiments, the epoxy is bis(4-glycidyloxyphenyl)methane. In some embodiments, the epoxy resin is bisphenol E diglycidyl ether (DGEBE). In some embodiments, the epoxy resin is 2,2′[1,1-ethanediylbis (4,1-phenyleneoxymethylene)]dioxirane. In some embodiments, the epoxy resin is bisphenol F diglycidyl ether (DGEBF). In some embodiments, the epoxy resin is poly(bisphenol A-co-epichlorohydrin).

In an aspect, the reactive species separate from the catechol-containing polymer or oligomer is an acrylate monomer or oligomer. In some embodiments, the acrylate monomer or oligomer is an acrylate monomer comprising a vinyl group and at least one of a carboxylic acid ester and a carboxylic acid nitrile; and wherein the acrylate is linear or branched.

In some embodiments, the acrylate monomer or oligomer is ethyl acrylate, ethylene-methyl acrylate, methyl methacrylate, 2-chloroethyl vinyl ether, 2-hydroxyethyl acrylate, hydroxyethyl methacrylate, butyl acrylate, trimethylolpropane triacrylate (TMPTA) or combinations thereof.

In some embodiments, the acrylate monomer or oligomer is ethyl acrylate. In some embodiments, the acrylate monomer or oligomer is ethylene-methyl acrylate. In some embodiments, the acrylate monomer or oligomer is methyl methacrylate. In some embodiments, the acrylate monomer or oligomer is 2-chloroethyl vinyl ether. In some embodiments, the acrylate monomer or oligomer is 2-hydroxyethyl acrylate. In some embodiments, the acrylate monomer or oligomer is hydroxyethyl methacrylate. In some embodiments, the acrylate monomer or oligomer is butyl acrylate. In some embodiments, the acrylate monomer or oligomer is trimethylolpropane triacrylate (TMPTA).

In some embodiments, the reactive species separate from the catechol-containing polymer or oligomer is a silane. In some embodiments, the reactive species separate from the catechol-containing polymer or oligomer is a methacrylate monomer or oligomer. In some embodiments, the reactive species separate from the catechol-containing polymer or oligomer is a methacrylate monomer. In some embodiments, the reactive species separate from the catechol-containing polymer or oligomer is a methacrylate oligomer.

In an aspect, the catechol-containing material 20 coated on the HPF 10 comprises the catalyst, co-catalyst or accelerator; and the catalyst, cocatalyst or accelerator is a urethane catalyst that promotes a urethane polymerization reaction, an epoxy catalyst that promotes an epoxy polymerization reaction, an acrylate catalyst that promotes an acrylate polymerization reaction, or combinations thereof.

In some embodiments, the catalyst, co-catalyst or accelerator is a urethane catalyst that promotes a urethane polymerization reaction. In some embodiments, the urethane catalyst is an aliphatic amine catalyst, an alicyclic amine catalyst, an alcohol amine catalyst, an aromatic amine catalyst, or an ether amine catalyst.

In some embodiments, the urethane catalyst is an aliphatic amine catalyst. In some embodiments, the aliphatic amine catalyst is N,N-dimethylcyclohexane, triethylenediamine, N,N,N,N-tetramethylalkylenediamine, N,N,N,N-pentamethyldiethylenetriamine, triethylamine, N,N-dimethylbenzylamine, N,N-dimethylhexadecylamine, N,N-dimethylbutylamine, or combinations thereof.

In some embodiments, the urethane catalyst is an alicyclic amine catalyst. In some embodiments, the alicyclic amine catalyst is triethylenediamine, N-ethylmorpholine, N-methylmorpholine, N,N-diethylpiperazine, N,N-bis-(α-hydroxypropyl)-2-methylpiperazine, N-hydroxypropyldimethylmorpholine, or combinations thereof.

In some embodiments, the urethane catalyst is an alcohol amine catalyst. In some embodiments, the alcohol amine catalyst is triethanolamine or N,N-demethylethanolamine.

In some embodiments, the urethane catalyst is an aromatic amine catalyst. In some embodiments, the aromatic amine catalyst is pyridine or N,N-dimethylpyridine.

In some embodiments, the urethane catalyst is an ether amine catalyst. In some embodiments, the ether amine catalyst is BDMAEE.

In some embodiments, the urethane catalyst is 1,4-diazabicyclo[2.2.2]octane, K-KAT 6212, benzyldimethylamine or combinations thereof. In some embodiments, the urethane catalyst is 1,4-diazabicyclo[2.2.2]octane. In some embodiments, the urethane catalyst is K-KAT 6212. In some embodiments, the urethane catalyst is benzyldimethylamine.

In some embodiments, the catalyst, co-catalyst or accelerator is an epoxy catalyst that promotes epoxy polymerization.

Suitable catalysts, co-catalysts or accelerators are substances which accelerate the reaction between amino groups and epoxy groups, such as acids or compounds hydrolyzable to acids. Without limitation, the suitable catalysts, co-catalysts or accelerators are organic carboxylic acids such as acetic acid, benzoic acid, salicylic acid, 2-nitrobenzoic acid, lactic acid; organic sulfonic acids such as methanesulfonic acid, p-toluenesulfonic acid or 4-dodecylbenzenesulfonic acid; sulfonic esters; other organic or inorganic acids such as phosphoric acid, or mixtures of the aforementioned acids and acid esters; nitrates such as calcium nitrate in particular; or tertiary amines such as 1,4 diazabicyclo[2.2.2]octane, benzyldimethylamine, α-methyl benzyldimethylamine, triethanolamine, dimethylaminopropylamine.

In some embodiments, the epoxy catalyst is acetic acid, benzoic acid, salicylic acid, 2-nitrobenzoic acid, lactic acid, methanesulfonic acid, p-toluenesulfonic acid, 4-dodecylbenzenesulfonic acid, sulfonic esters, phosphoric acid, calcium nitrate, 1,4-diazabicyclo-[2.2.2]octane, benzyldimethylamine, α-methyl benzyldimethylamine, triethanolamine, dimethylaminopropylamine, N,N-dimethylpiperidine, triethylenediamine, 2,4,6-tris (dimethylaminomethyl) phenol (DMP-30), benzyldimethyl-amine (BDMA), 2-(dimethyl-aminomethyl)phenol (DMP-10), N,N dimethylbenzylamine, (dimethylaminomethyl)phenol or combinations thereof.

In some embodiments, the epoxy catalyst is 1,4-diazabicyclo[2.2.2]octane.

In some embodiments, the catalyst, co-catalyst or accelerator is an acrylate catalyst that promotes acrylate polymerization. In some embodiments, the acrylate catalyst is an acrylic or a free-radical polymerization promoter.

In some embodiments, the acrylate catalyst is methyl 4-N,N-dimethylamino-phenylacetate (MDMAPA), N,N-dimethylaminoglutethimide (OMAG), N,N-dimethyl-p-toluidine (OMPT), N,N-di-2-Hydroxyethyl-p-toluidine (DHEPT), N,N-di-2-hydroxypropyl-p-toluidine (DHPPT), N,N-dimethyl-sym-xylidine (DMSX), N,N-Bis(3-p-tolyloxy-2-hydroxy-propyl)-m-xylidine (BTX) or combinations thereof.

In an aspect, the catechol-containing polymer or oligomer in the catechol-containing material coated on the HPF 20 comprises poly-catechol styrene (PCS).

In an aspect, the catechol-containing material such 20 as PCS coated on the HPF 10 has a thickness of from about 5 nanometers to about 100 microns. In some embodiments, the catechol-containing material such as PCS coated on the HPF 20 has a thickness of from about 15 nanometers to about 50 microns. In some embodiments, the catechol-containing material such as PCS coated on the HPF 20 has a thickness of from about 15 nanometers to about 15 microns. In some embodiments, the catechol-containing material such as PCS coated on the HPF 20 has a thickness of from about 100 nanometers to less than about 5 microns. In some embodiments, the catechol-containing material such as PCS coated on the HPF 20 has a thickness of from about 150 nanometers to about 1.5 microns.

In some embodiments, the catechol-containing material such as PCS coated on the HPF 20 has a thickness of from about 10 nanometers to about 100 microns; or from about 10 nanometers to about 100 nanometers; or from about 100 nanometers to about 150 nanometers; or from about 150 nanometers to about 200 nanometers; or from about 200 nanometers to about 250 nanometers; or from about 250 nanometers to about 300 nanometers; or from about 300 nanometers to about 350 nanometers; or from about 350 nanometers to about 400 nanometers; or from about 400 nanometers to about 450 nanometers; or from about 450 nanometers to about 500 nanometers; or from about 500 nanometers to about 550 nanometers; or from about 550 nanometers to about 600 nanometers; or from about 600 nanometers to about 650 nanometers; or from about 650 nanometers to about 700 nanometers; or from about 700 nanometers to about 750 nanometers; or from about 750 nanometers to about 800 nanometers; or from about 800 nanometers to about 850 nanometers; or from about 850 nanometers to about 900 nanometers; or from about 900 nanometers to about 950 nanometers; or from about 950 nanometers to about 1000 nanometers.

In some embodiments, the catechol-containing material such as PCS coated on the HPF 20 has a thickness of from about 1 micron to about 1.5 microns; or from about 1.5 microns to about 5 microns; or from about 5 microns to about 10 microns; or from about 10 microns to about 15 microns; or from about 15 microns to about 20 microns; or from about 20 microns to about 25 microns; or from about 25 microns to about 30 microns; or from about 30 microns to about 35 microns; or from about 35 microns to about 40 microns; or from about 40 microns to about 45 microns; or from about 45 microns to about 50 microns; or from about 50 microns to about 55 microns; or from about 55 microns to about 60 microns; or from about 60 microns to about 65 microns; or from about 65 microns to about 70 microns; or from about 70 microns to about 75 microns; or from about 75 microns to about 80 microns; or from about 80 microns to about 85 microns; or from about 85 microns to about 90 microns; or from about 90 microns to about 95 microns; or from about 95 microns to about 100 microns.

In some embodiments, the aggregate thickness of the catechol-containing materials such as PCS coated on the high-performance fiber (HPF) is in the range of the about 5 nanometers to about 10 microns. Stated differently, the aggregate thickness is any one number selected from the following set of numbers or within a range defined by any two numbers including the endpoints of such a range measured in nanometers:

5, 10, 15, 20, 25, 30, 35, 40, 45, 50, 55, 60, 65, 70, 75, 80, 85, 90, 95, 100, . . . 200, . . . 300, . . . 400, 500, 600, 700, 800 . . . , 900, . . . 1000, 2000, 3000, 4000, 5000, 6000, 7000, 8000, 9000, and 10000.

In some embodiments, the PCS comprises from about 5% catechol to about 85% catechol. In some embodiments, the PCS comprises from about 10% to 75%, from about 15 to 60%, or from about 20% catechol to about 40% catechol. In some embodiments, the PCS comprises from about 25% catechol to about 35% catechol. In some embodiments, the PCS comprises about 25% catechol. In some embodiments, the PCS comprises about 35% catechol.

In some embodiments, the PCS comprises from about 20% catechol to about 22% catechol; or from about 22% catechol to about 24% catechol; or from about 24% catechol to about 26% catechol; or from about 26% catechol to about 28% catechol; or from about 28% catechol to about 30% catechol; or from about 30% catechol to about 32% catechol; or from about 32% catechol to about 34% catechol; or from about 34% catechol to about 36% catechol; or from about 36% catechol to about 38% catechol; or from about 38% catechol to about 40% catechol.

In some embodiments, the PCS comprises from about 5% catechol to about 85% catechol. Stated differently, the catechol content in the PCS is any one number selected from the following set of numbers or within a range defined by any two numbers including the endpoints of such a range measured in weight content:

5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, and 85.

In an aspect, the catechol-containing material coated on the HPF 20 is a continuous layer. In an aspect, the catechol-containing material coated on the HPF 20 is a non-continuous layer.

In some embodiments, the HPF 10 is wet. In some embodiments, the HPF 10 is dry. In some embodiments, the HPF 10 is semi-wet. In some embodiments, the HPF 10 is moist.

In some embodiments, the surface of the HPF 10 may be treated prior to disposition of the catechol-containing material coated on the HPF. In some embodiments, the surface of the HPF 10 is anodized. In some embodiments, the surface of the HPF 10 is phosphated.

The embodiments of the present disclosure have been described in terms of a catechol-containing material coated on the HPF.

In one aspect, the disclosure is directed to a catechol-containing material 20 coated on the HPF 10, as described herein, which may also be in contact with another polymer 30.

In some embodiments, the polymer 30 comprises a polyester. In some embodiments, the polymer 30 comprises a urethane. In some embodiments, the polymer 30 comprises a phenol. In some embodiments, the polymer 30 comprises an epoxy, an acrylic or a silane. In some embodiments, the polymer 30 comprises an epoxy. In some embodiments, the polymer 30 comprises an acrylic. In some embodiments, the polymer 30 comprises a silane. In some embodiments, the polymer 30 comprises a silicone.

In some embodiments, the polymer 30 comprises one or more polymers listed in Table 1 infra, and from the following list:

### Thermoplastics

Polypropylene, Polyethylene (High Density and Low Density), Polycarbonate, Polyvinyl Chloride (PVC), Polyetheretherketone (PEEK), Polyethersulfone (PES), Polyphenylene Sulfide (PPS), Polyamide (Nylon), Polymethyl Methacrylate (PMMA), Polyetherimide (PEI), Acetal (POM), Sulfone Polymers (PPSU, PSU), Ethylene-Vinyl Acetate (EVA), Liquid Crystal Polymers (LCP), Polybutylene Terephthalate (PBT), Acrylonitrile Butadiene Styrene (ABS), Fluoropolymers (PTFE, FEP), Thermoplastic Elastomers (TPE), Thermoplastic Polyurethane (TPU), Polycyclohexylenedimethylene Terephthalate (PCT).

### Thermosets

Epoxy Resins, Polyester Resins, Vinyl Ester Resins, Phenolic Resins, Polyimides, Polyurethane, Polystyrene, Silicone Resins, Cyanate Esters, Melamine-Formaldehyde Resins, Polydicyclopentadiene (pDCPD), Polyarylate (PAR), Polybenzimidazole (PBI), Polychlorotrifluoroethylene (PCTFE), Methyl Methacrylate-Butadiene-Styrene (MBS).

### Other

Polyacrylonitrile (PAN), Polyhydroxyalkanoates (PHA), Bio-based Polymers (PLA, PHB), Polyoxymethylene Copolymer (POM-C).

In some embodiments, the polymer 30 is a continuous layer. In some embodiments, the polymer 30 is a non-continuous layer.

In some embodiments, the catechol-containing material 20 and the polymer 30 form an interpenetrating polymer network (IPN). An IPN as used herein is taken to mean at least two polymer networks that are at least partially interlaced on a molecular scale but not covalently bonded to each other and cannot be separated unless chemical bonds are broken.

In some embodiments, the catechol-containing material 20 and the polymer 30 form a semi-interpenetrating polymer network (SIPN). A SIPN as used herein is taken to mean one or more polymer networks and one or more linear or branched polymer(s) characterized by the penetration on a molecular scale of at least one of the networks by at least some of the linear or branched macromolecules.

In some embodiments, the catechol-containing material 20 and the polymer 30 form a sequential interpenetrating polymer network (SeIPN). A SeIPN as used herein is taken to mean an interpenetrating polymer network prepared by a process in which the second component network is formed following the formation of the first component network.

In some embodiments, the catechol-containing material 20 and the polymer 30 form a sequential semi-interpenetrating polymer network (SSeIPN). A SSeIPN as used herein is taken to mean a polymer network prepared by a process in which the linear or branched components are formed following the completion of the reactions that lead to the formation of the network(s) or vice versa.

In some embodiments, a second polymer 50 is disposed on the polymer 30. In some embodiments, the second polymer 50 is disposed on and in contact with the polymer 30. In some embodiments, a second catechol-containing material 20 is disposed between the polymer matrix 30 and the second polymer 50.

V. Methods of Making the HPF with a Coating of Catechol-Containing Materials

In an aspect, the disclosure is directed to methods of making a HPF coated with catechol-containing materials such as PCS, comprising disposing the catechol-containing material 20 described herein on a surface of the HPF 10. The methods of disposing the catechol-containing materials 20 described herein are not particularly limited and will be recognized by those skilled in the art.

In some embodiments, the methods of making a coated HPF comprise disposing the catechol-containing material 20 on a HPF 10 (for example, in a bulk) by spin coating, dip coating, spray coating, ink jet printing, flood coating, brushing, wiping, or the like. In some embodiments, the methods comprise disposing the catechol-containing material 20 on a high-performance fiber 10 by spin coating. In some embodiments, the methods comprise disposing the catechol-containing material 20 on a high-performance fiber 10 by dip coating. In some embodiments, the methods comprise disposing the polymeric layer 20 on a high-performance fiber 10 by spray coating. In some embodiments, the methods comprise disposing the catechol-containing material 20 on a high-performance fiber 10 by ink jet printing. In some embodiments, the methods comprise disposing the catechol-containing material 20 on a high-performance fiber 10 by flood coating. In some embodiments, the methods comprise disposing the catechol-containing material 20 on a high-performance fiber 10 by brushing. In some embodiments, the methods comprise disposing the catechol-containing material 20 on a high-performance fiber 10 by wiping.

In some embodiments, the methods of making a high-performance fiber comprise disposing the catechol-containing material 20 on a high-performance fiber 10, wherein the catechol-containing material 20 is applied to the high-performance fiber 10 as a solution. In some embodiments, the solution comprises from about 0.001% by weight to about 10% by weight of the catechol-containing polymer or oligomer. In some embodiments, the solution comprises from about 0.01% by weight to about 5% by weight of the catechol-containing polymer or oligomer. In some embodiments, the solution comprises from about 0.01% by weight to about 1% by weight of the catechol-containing polymer or oligomer. In some embodiments, the solution comprises from about 0.1% by weight to about 1% by weight of the catechol-containing polymer or oligomer.

In some embodiments, the solution comprises from about 0.001% by weight to about 0.005% by weight of the catechol-containing polymer or oligomer; or from about 0.005% by weight to about 0.01% by weight of the catechol-containing polymer or oligomer; or from about 0.01% by weight to about 0.02% by weight of the catechol-containing polymer or oligomer; or from about 0.02% by weight to about 0.03% by weight of the catechol-containing polymer or oligomer; or from about 0.03% by weight to about 0.04% by weight of the catechol-containing polymer or oligomer; or from about 0.04% by weight to about 0.05% by weight of the catechol-containing polymer or oligomer; or from about 0.05% by weight to about 0.06% by weight of the catechol-containing polymer or oligomer; or from about 0.06% by weight to about 0.07% by weight of the catechol-containing polymer or oligomer; or from about 0.07% by weight to about 0.08% by weight of the catechol-containing polymer or oligomer; or from about 0.08% by weight to about 0.09% by weight of the catechol-containing polymer or oligomer; or from about 0.09% by weight to about 0.1% by weight of the catechol-containing polymer or oligomer; or from about 0.1% by weight to about 0.11% by weight of the catechol-containing polymer or oligomer; or from about 0.11% by weight to about 0.12% by weight of the catechol-containing polymer or oligomer; or from about 0.12% by weight to about 0.13% by weight of the catechol-containing polymer or oligomer; or from about 0.13% by weight to about 0.14% by weight of the catechol-containing polymer or oligomer; or from about 0.14% by weight to about 0.15% by weight of the catechol-containing polymer or oligomer; or from about 0.15% by weight to about 0.2% by weight of the catechol-containing polymer or oligomer; or from about 0.2% by weight to about 0.25% by weight of the catechol-containing polymer or oligomer; or from about 0.25% by weight to about 0.3% by weight of the catechol-containing polymer or oligomer; or from about 0.3% by weight to about 0.35% by weight of the catechol-containing polymer or oligomer; or from about 0.35% by weight to about 0.4% by weight of the catechol-containing polymer or oligomer; or from about 0.4% by weight to about 0.45% by weight of the catechol-containing polymer or oligomer; or from about 0.45% by weight to about 0.5% by weight of the catechol-containing polymer or oligomer; or from about 0.5% by weight to about 0.75% by weight of the catechol-containing polymer or oligomer; or from about 0.75% by weight to about 1% by weight of the catechol-containing polymer or oligomer; or from about 1.25% by weight to about 1.5% by weight of the catechol-containing polymer or oligomer; or from about 1.5% by weight to about 1.75% by weight of the catechol-containing polymer or oligomer; or from about 1.75% by weight to about 2% by weight of the catechol-containing polymer or oligomer.

In some embodiments, the catechol-containing polymer or oligomer used in the solution is poly-catechol styrene (PCS). In some embodiments, the solution comprises from about 0.001% by weight to about 10% by weight of PCS. In some embodiments, the solution comprises from about 0.01% by weight to about 5% by weight of PCS. In some embodiments, the solution comprises from about 0.01% by weight to about 1% by weight of PCS. In some embodiments, the solution comprises from about 0.1% by weight to about 1% by weight of PCS.

In some embodiments, the solution comprises from about 0.001% by weight to about 0.005% by weight of PCS; or from about 0.005% by weight to about 0.01% by weight of PCS; or from about 0.01% by weight to about 0.02% by weight of PCS; or from about 0.02% by weight to about 0.03% by weight of PCS; or from about 0.03% by weight to about 0.04% by weight of PCS; or from about 0.04% by weight to about 0.05% by weight of PCS; or from about 0.05% by weight to about 0.06% by weight of PCS; or from about 0.06% by weight to about 0.07% by weight of PCS; or from about 0.07% by weight to about 0.08% by weight of PCS; or from about 0.08% by weight to about 0.09% by weight of PCS; or from about 0.09% by weight to about 0.1% by weight of PCS; or from about 0.1% by weight to about 0.11% by weight of PCS; or from about 0.11% by weight to about 0.12% by weight of PCS; or from about 0.12% by weight to about 0.13% by weight of PCS; or from about 0.13% by weight to about 0.14% by weight of PCS; or from about 0.14% by weight to about 0.15% by weight of PCS; or from about 0.15% by weight to about 0.2% by weight of PCS; or from about 0.2% by weight to about 0.25% by weight of PCS; or from about 0.25% by weight to about 0.3% by weight of PCS; or from about 0.3% by weight to about 0.35% by weight of PCS; or from about 0.35% by weight to about 0.4% by weight of PCS; or from about 0.4% by weight to about 0.45% by weight of PCS; or from about 0.45% by weight to about 0.5% by weight of PCS; or from about 0.5% by weight to about 0.75% by weight of PCS; or from about 0.75% by weight to about 1% by weight of PCS; or from about 1.25% by weight to about 1.5% by weight of PCS; or from about 1.5% by weight to about 1.75% by weight of PCS; or from about 1.75% by weight to about 2% by weight of PCS.

In some embodiments, the solution comprises catechol-containing polymer or oligomer such as PCS in a weight percent as recited by the numbers below or by a number within a range defined by any two numbers below, including the endpoints of such range:

0.001, 0.002, 0.003, 0.004, 0.005, 0.006, 0.007, 0.008, 0.009, 0.010, . . . , 0.020, 0.030, 0.040, 0.050, 0.060, 0.070, 0.080, 0.090, 0.100, . . . 0.200, 0.300, 0.400, 0.500, 0.600, 0.700, 0.800, 0.900, 1.000, . . . , 2.000, 3.000, 4.000, 5.000, 6.000, 7.000, 8.000, 9.000, and 10.000.

In some embodiments, the PCS-type catechol-containing material concentration can be as high as 20%.

In some embodiments, the solution also comprises an aqueous or organic solvent for dissolving the catechol-containing polymer or oligomer. In some embodiments, the organic solvent is acetone, toluene, chloroform, dichloromethane (DCM), ethyl acetate, methyl ethyl ketone (MEK) or a combination thereof.

In some embodiments, the organic solvent is acetone. In some embodiments, the organic solvent is toluene. In some embodiments, the organic solvent is chloroform. In some embodiments, the organic solvent is dichloromethane (DCM). In some embodiments, the organic solvent is ethyl acetate. In some embodiments, the organic solvent is methyl ethyl ketone (MEK). In some embodiments, the organic solvent is a combination of acetone and toluene. In some embodiments, the organic solvent is acetone and the catechol-containing polymer or oligomer is PCS. In some embodiments, the organic solvent is toluene and the catechol-containing polymer or oligomer is PCS. In some embodiments, the organic solvent is a combination of acetone and toluene and the catechol-containing polymer or oligomer is PCS.

The pH of the solution is not particularly limited. In some embodiments, the pH of the solution is about 3; or about 3.5; or about 4; or about 4.5; or about 5; or about 5.5; or about 6; or about 6.5; or about 7; or about 7.5; or about 8; or about 8.5; or about 9; or about 9.5; or about 10; or about 10.5; or about 11.

In some embodiments, the pH of the solution is from about 3-3.5; or about 3.5-4; or about 4-4.5; or about 4.5-5; or about 5-5.5; or about 5.5-6; or about 6-6.5; or about 6.5-7; or about 7-7.5; or about 7.5-8; or about 8-8.5; or about 8.5-9; or about 9-9.5; or about 9.5-10; or about 10-10.5; or about 10.5-11.

In one embodiment, the molecular weight of the PCS monomer/oligomer/polymer ranges from as low as 4000 Da to as high as 1000,000. This does not preclude the lower molecular weight oligomers or higher molecular weight polymers to be amenable to present disclosure.

In one embodiment, the molecular weight of the PCS material is any one of the numbers given below in Kilodaltons as well as any number that is within a range defined by any two numbers below, including their endpoints: 0.2, 0.4, 0.6, 0.8, 1, 2, 3, 4, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, and 1000.

Clearly, the above range includes monomeric moieties, oligomeric moieties, and polymeric moieties of catechol-styrene.

### VI. High-Performance Fiber-Reinformed Composite Polymeric Structures

In one embodiment, the HPF coated with the catechol-containing sizing agent such as PCS of the present disclosure are used to prepare the FRCP s polymer structures and articles. Thermoset and thermoplastic polymers are used as matrix materials, such as described below. The carbon fibers that are coated with the catechol-containing material such as PCS are then used in the following matrices to prepare the fiber-reinforced composites.

TABLE 1

| Types of matrix | Thermoset or |
|---|---|
| materials | Thermoplastic |
| Epoxy | Thermoset |
| Hardened Epoxy | Thermoset |
| Polyester | Thermoset |
| Polyurethane | Thermoset |
| Polyimide | Thermoset |
| Phenolic | Thermoset |
| Cyanic ester | Thermoset |
| Bismaleimide | Thermoset |
| Polyethylene | Thermoplastic |
| PEEK and polyarylether- | Thermoplastic |
| ketones (PAEK) | |
| Polypropylene | Thermoplastic |
| Nylon | Thermoplastic |
| Teflon | Thermoplastic |
| Polyetherimide | Thermoplastic |
| Polybenzimidazole | Thermoplastic |
| Polyurethane | Thermoplastic |
| Polyester | Thermoset or |
| | Thermoplastic |
| Epoxy | Thermoset |
| Hardened Epoxy | Thermoset |
| Polyester | Thermoset and |
| | Thermoplastic |
| Polyurethane | Thermoset |
| Polyimide | Thermoset |
| Phenolic | Thermoset |
| Cyanic ester | Thermoset |
| Bismaleimide | Thermoset |
| Polyethylene | Thermoplastic |
| PEEK | Thermoplastic |
| Polypropylene | Thermoplastic |
| Nylon | Thermoplastic |
| Teflon | Thermoplastic |
| Polyetherimide | Thermoplastic |

Examples of suitable plastic materials include thermoplastic polymers, thermoset polymers, resins, and cross-linking resins, including, for example, polyphenylene sulfide (PPS), and polyetherketoneketone (PEKK). The thermoplastic polymer matrix material may include any one of various suitable thermoplastic polymers, such as polypropylene (PP), polyethylene (PE), and polyvinylchloride (PVC).

Some of the matrix resins that can be used as matrix to prepare the fiber-reinforced composite from the HPF of the present disclosure are as follows:

### Thermoplastics

Polypropylene, Polyethylene (High Density and Low Density), Polycarbonate, Polyvinyl Chloride (PVC), Polyetheretherketone (PEEK), Polyethersulfone (PES), Polyphenylene Sulfide (PPS), Polyamide (Nylon), Polymethyl Methacrylate (PMMA), Polyetherimide (PEI), Acetal (POM), Sulfone Polymers (PPSU, PSU), Ethylene-Vinyl Acetate (EVA), Liquid Crystal Polymers (LCP), Polybutylene Terephthalate (PBT), Acrylonitrile Butadiene Styrene (ABS), Fluoropolymers (PTFE, FEP), Thermoplastic Elastomers (TPE), Thermoplastic Polyurethane (TPU), Polycyclohexylenedimethylene Terephthalate (PCT).

### Thermosets

Epoxy Resins, Polyester Resins, Vinyl Ester Resins, Phenolic Resins, Polyimides, Polyurethane, Polystyrene, Silicone Resins, Cyanate Esters, Melamine-Formaldehyde Resins, Polydicyclopentadiene (pDCPD), Polyarylate (PAR), Polybenzimidazole (PBI), Polychlorotrifluoroethylene (PCTFE), Methyl Methacrylate-Butadiene-Styrene (MBS).

### Other

Polyacrylonitrile (PAN), Polyhydroxyalkanoates (PHA), Bio-based Polymers (PLA, PHB), Polyoxymethylene Copolymer (POM-C).

VII. Articles from Fiber-Reinforced Composite (FRC)

In one aspect of the present disclosure, articles are prepared from FRC described above.

In addition to coating of the individual carbon fibers, PCS-type material can be used as a thin film primer for HPF fiber parts. In one embodiment, the parts are dipped into a self-polymerizing container for example of oligomeric catechol-containing materials such as the oligomer of PCS, and allowed to polymerize, creating a layer of PCS on the carbon fiber surface. Alternatively, a polymeric PCS in solution form as described in this disclosure can be used for dip-coating or spray-coating a part or an article formed from an HPF of the present disclosure. Stated differently, in one embodiment, this disclosure relates to preparing a part from the HPF fibers described herein, and coating such part with a PCS-type material in a solution (dissolved in a solvent such as acetone).

In one embodiment of the present disclosure, a fiber-reinforced composite polymer is prepared from using one or more HPF fibers as described herein, with or without being coated with the PCS-type coating material, with the matrix being one or more matrix polymers and resins as described herein. An article is made from such a fiber-reinforced composite polymer.

In one embodiment, this disclosure provides a method for applying a coating to at least one face of a substrate made of fiber-reinforced thermoplastic composite material as described herein (sizing with and without PCS-type material), wherein the method comprises a first step of applying a PCS-type layer optionally filled with particles of graphene or of zinc to the face of the substrate as a primer, then a second step of applying the coating to the zinc or graphene particle-filled adhesive PCS-type layer.

Using a PCS-type layer produces a high level of adhesion between the substrate and the coating, despite the low surface energy of the fiber-reinforced thermoplastic composite material substrate.

The adhesive PCS-type layer has a thickness of between 100 nm and 100 μm; the adhesive PCS-type layer is filled with graphene and comprises from 0.5% to 2% by weight of graphene.

The disclosure also provides a substrate such as an airplane part comprising, on at least one face, a coating, wherein the substrate comprises a zinc or graphene particle-filled adhesive PCS-type layer as primer interposed between the face of the substrate and the coating.

According to an embodiment, panel is made of FRC material. As an example, the panel comprises carbon fibers embedded in a thermoplastic resin matrix, of PEEK, PEKK, PAEK or PPS type, for example.

This coating comprises at least one paint or protective layer. According to an embodiment, the coating comprises at least one anticorrosion layer, at least one paint layer, and at least one varnish layer. These different layers are applied in the same way as would be done in the prior art.

According to one procedure, the application method comprises a preparatory step on the face of the substrate, such as a degrease, for example, before the step of applying the adhesive PCS-type layer. This latter layer may be applied in non-aqueous solution to the face of the substrate, by spraying or dip-coating, for example.

According to an embodiment, the adhesive PCS-type layer is filled with graphene particles. The adhesive PCS-type layer comprises 0.5% to 2% by weight of graphene. In one configuration, the graphene particles are present in the form of platelets. By virtue of the graphene present, the adhesive PCS-type layer is electrically and thermally conductive. The graphene present also gives the layer anticorrosion properties.

According to an embodiment, the adhesive PCS-type layer is filled with zinc particles in order to endow it with anticorrosion properties and to obtain an anticorrosion barrier without either chromium or cadmium. In this embodiment, the adhesive PCS layer comprises from 0.5% to 2% by weight of zinc.

Using an adhesive PCS-type layer produces a high level of adhesion between the substrate and the coating, in spite of the low surface energy of the thermoplastic composite material substrate, without any need for a surface treatment such as a plasma treatment.

When the adhesive PCS-type layer is filled with graphene, it forms an anti-lightning layer, which may assist or replace another anti-lightning layer such as a metallic mesh. Adding graphene to the adhesive PCS-type layer is more effective than adding the same amount of graphene to the PCS in order to obtain an anti-lightning layer, since the thickness of the adhesive PCS-type layer is significantly less than that of the coating and allows a greater concentration of graphene to be obtained.

According to an embodiment, a composite material panel of the prior art, covered with a first coating, comprises a metallic mesh interposed between the panel and the first coating, forming an anti-lightning layer. A panel of this kind may have a damaged region on the surface, at which the metallic mesh and the first coating are no longer present. According to another advantage of the disclosure, a panel of this kind may be repaired by covering the damaged region with a graphene particle-filled adhesive PCS-type layer and then with a second coating. Following the repair, the adhesive PCS-type layer in contact with the metallic mesh ensures the continuity of the anti-lightning layer, while the second coating ensures the continuity of the first coating.

### EXPERIMENTAL

### Example 1: Aramid Fibers as High-Performance Fibers

As described above, this disclosure relates to high-performance fibers (HPF) such as HPP (high-performance, polymeric) fiber coated with poly-catechol styrene (PCS). In this experiment, raw aramid fibers (AF; 25 g) were placed in a glass reaction vessel. To the vessel was added 1 L of acetone and stirred for 1 hour to clean the aramid fibers.

A portion of the fibers were separated and dried, the rest were put into 1 L of acetone with 60 g of ZnCl₂ solution and stirred for 6 hours to break the hydrogen bonds of the fibers (without wishing to be bound by this theory, we speculate) to functionalize them. A portion of the fibers were separated and dried, the rest were put into 1 L of acetone with 5 g of PCS and stirred for 1 hour.

Vacuum filtration was used to filter the fibers from each solution. The filtered fibers were rinsed with 1× phosphate buffer saline (PBS) and isopropyl alcohol to remove any residue, unbound PCS, and debris not adhered to the fibers.

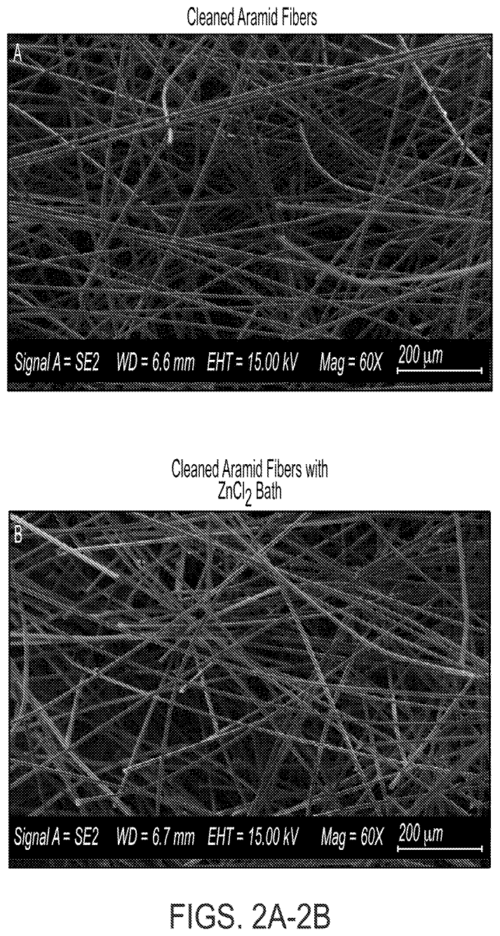

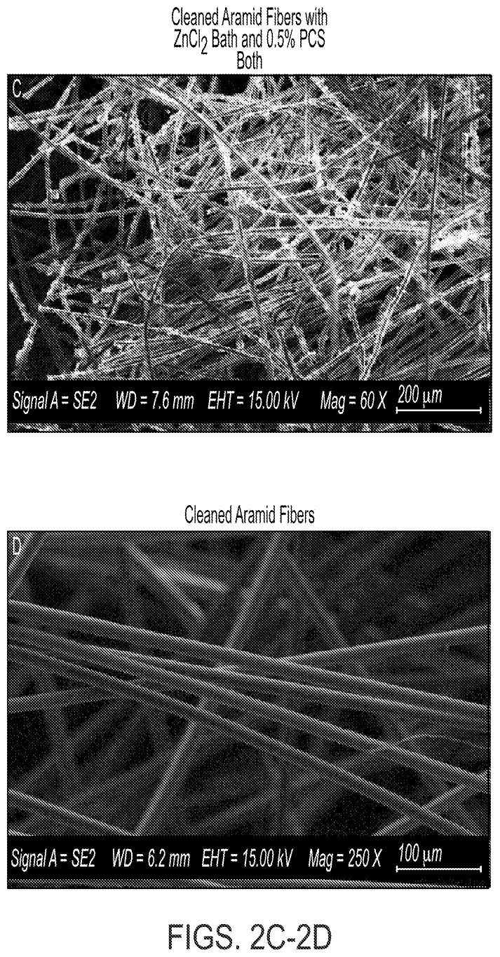

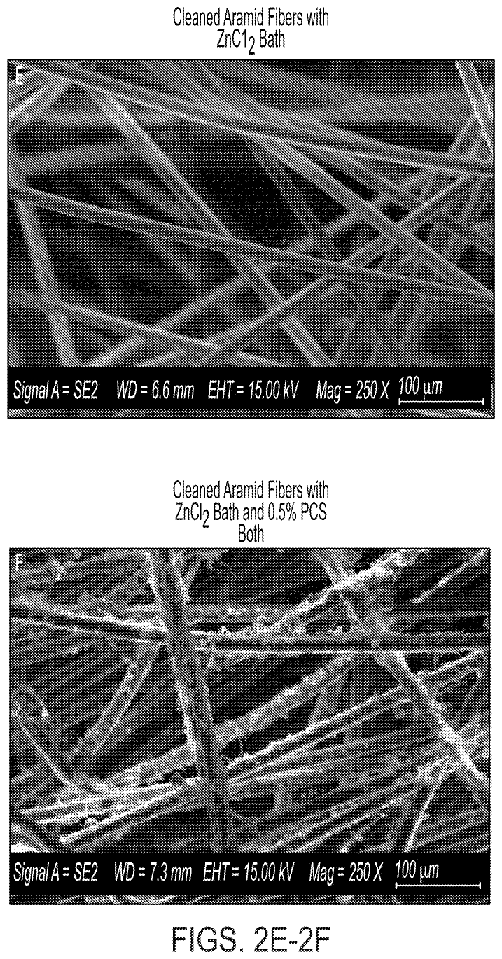

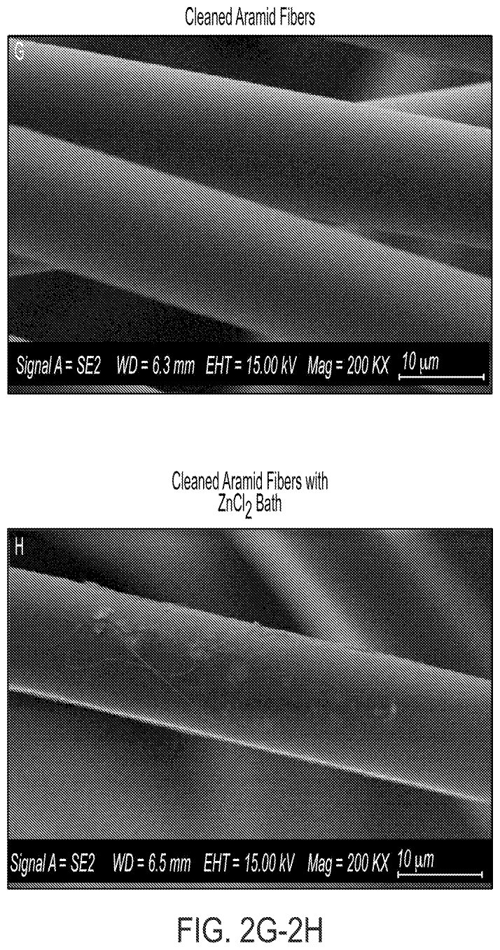

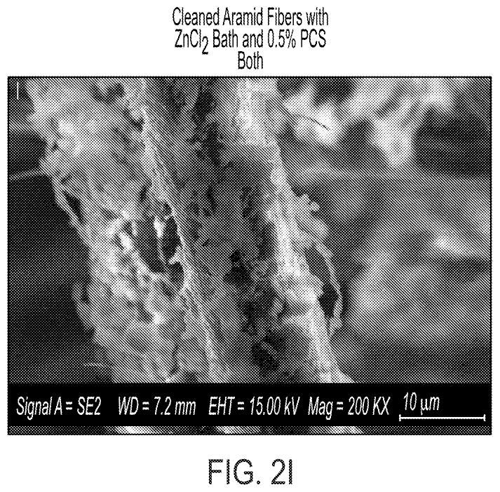

After drying in a vacuum chamber at 25° C., the fibers were analyzed using SEM. Through visual inspection under magnification, it was observed that the fibers had a thin film coating. The resulting SEM images are below, in FIGS. 2A-2C; 2D-2F; and 2G-2I. FIGS. 2A-2C depict a lower magnification, FIGS. 2D-2F depict a higher magnification; and FIGS. G-2I depict the highest magnification used as shown in the SEMs. FIGS. 2A, 2D, and 2G depict the cleaned aramid fibers; FIGS. 2B, 2E, and 2H depict the ZnCl₂ treated cleaned aramid fibers; and FIGS. 2C, 2F, and 2I depict the aramid fibers subsequently coated with ZnCl₂+PCS.

This disclosure pertains to individual aramid fibers that are coated with a thin poly(catechol-styrene) (PCS) film. This thin polymer film functionalizes the previously inert aramid fiber surface with catechol moieties that can aid in adhesion to the matrix of various thermoset and thermoplastic composite materials. In one embodiment, the method of coating comprises of simply stirring raw aramid fibers in an organic solvent with dissolved PCS. The PCS in the solution forms bonds with the aramid fiber surface leaving a thin film deposited. Following this coating reaction, the fibers are filtered, rinsed with isopropyl alcohol and DI water, and left to dry in a vacuum chamber to remove any residual solvent.

This one step coating process is advantageous to many other coating processes. Previous AF coating using mussel inspired materials (specifically polydopamine) require a self-polymerizing reaction to occur. This reaction in difficult to manage and control and is not easily scalable. The advantage of PCS is that it is pre-polymerized, so the coating process simply comprises of allowing the preformed catechol-containing polymer to interact with the aramid fiber surface. Current experiments have been performed at room temperature with a 5:1 by wt. ratio of AF:PCS in an acetone bath.

In one embodiment, this disclosure relates to individual and plurality of HPP fibers that are coated with a thin poly(catechol-styrene) (PCS) film. This thin polymer film functionalizes the previously inert carbon fiber surface with catechol moieties that can aid in adhesion to the matrix of various thermoset and thermoplastic composite materials. The method of coating comprises stirring raw carbon fibers in an organic solvent with dissolved PCS. The PCS from in the solution forms bonds with the carbon fiber surface leaving a thin film deposited. Following this coating reaction, the fibers are filtered, rinsed with isopropyl alcohol and DI water, and dried, preferably in a vacuum chamber to remove any residual solvent.

This one step coating process is advantageous to many other coating processes. The advantage of PCS is that it is pre-polymerized, so in one embodiment of the coating process the pre-formed catechol-containing polymer interacts with the carbon fiber surface.

Current experiments have been performed at room temperature with a 5:1 by wt. ratio of HPP fiber:PCS in an acetone bath. Coating process variables such as temperature, inert atmospheres, addition of oxidizing agents, varying materials ratios and the like can be adjusted to provide a more optimized coating of the fiber.

These coated fibers are incorporated into a composite matrix to create fiber reinforced materials.

### The Coating Process

In the first step, 25 g of raw chopped aramid fibers were added to a 4 liter reaction flask.
1 Liter of acetone was added to the reaction flask.
AF and acetone were stirred for 1 hour at room temperature in a sealed reaction flask.
A portion of the fibers were separated and dried, the others were put into a reaction flask of 1 liter acetone and 60 g ZnCl₂.
AF were stirred in the 6% ZnCl₂ bath for 6 hours at room temperature in a sealed reaction flask.
A portion of the fibers were separated and dried, the others were put into a reaction flask of 1 liter acetone and 5 grams of PCS. The PCS dissolved into the organic solvent.
AF were stirred in the 0.5% PCS bath for 1 hour at room temperature in a sealed reaction flask.
The fibers were filtered from the liquid media and rinsed with 1× phosphate buffer saline followed by isopropanol to remove any loose PCS and other debris.
The fibers were analyzed under SEM, and images 2A-2I were taken.

In FIG. 2, SEM micrographs are shown of aramid fibers without any coating treatment (2A, 2D, 2G); fibers with a 6% ZnCl₂ bath (2B, 2E, 2H); and fibers treated in a ZnCl₂ bath and PCS coating (2C, 2F, 2I). The (2A, 2D, 2G) aramid fibers are the ones that have been cleaned with a one hour acetone bath. The (2B, 2E, 2H) are a portion of the cleaned aramid fibers that were stirred in a 6% ZnCl₂ bath for six hours. The (2C, 2F, 2I) aramid fibers are a portion of the ZnCl₂ treated fibers that were stirred in a 0.5% PCS bath for one hour. The PCS coated fibers were then washed with 1× phosphate buffer saline and then isopropanol to remove any unbound PCS from the fibers. (I) PCS can be seen adhering to and coating individual aramid fibers. The ZnCl₂ bath is necessary to break the hydrogen bonds formed between the aramid fibers themselves, thus improving the fiber's surface modification ability and allows the site to form new hydrogen bonds. The extensive coating on the aramid fibers is most likely a result from the hydrogen bonds made between the aramid fibers and the functional catechol groups of PCS. Panels 2D, 2G are magnified views at 250× and 2K×, respectively, of panel 2A at 50×. Panels 2E, 2H are magnified views at 250× and 2K×, respectively, of panel 2B at 60×. Panels 2F, 2I are magnified views at 250× and 2K×, respectively, of panel 2C at 60×. Scale bars of panels 2A, 2B, 2C are 200 microns, panels 2D, 2E, 2F are 100 microns, and panels 2G, 2H, 2I are 10 microns.

It was surprising that simply stirring dissolved PCS with raw aramid fiber in an organic solvent resulted in the polymer coating. The fact that no heat or other reactants were required to stimulate the reaction between the materials seems to indicate the strong affinity that PCS has for the aramid fiber surface.

The HPP fiber can be chopped strands and may be any of polymer type: polyaramid, polyester, and UHMWPE. The length of the HPP fiber chopped strands is not critical, but in one embodiment, it is 5 microns to 50 mm. The diameter and the number of filaments which constitute the HPP fiber chopped strand are also not critical, but in one embodiment, the diameter is usually 500 nm-50 micron. and the number of the filaments is usually 100-100,000. The HPP fiber chopped strands may be previously applied with a sizing agent.

### Example 2: Carbon Fiber as High-Performance Fiber

As described previously, this disclosure relates to carbon fiber (CF) coated with poly-catechol styrene (PCS). In this experiment raw carbon fibers (25 g) were placed in a glass reaction vessel. To the vessel was added 1 L of acetone and 4 g of Poly(catechol-styrene). Using an overhead stirrer, the mixture was stirred for 24 hours at room temperature. Vacuum filtration was used to filter the fibers from the solution. The filtered fibers were rinsed with isopropyl alcohol and deionized water to remove any residue and debris not adhered to the fibers.

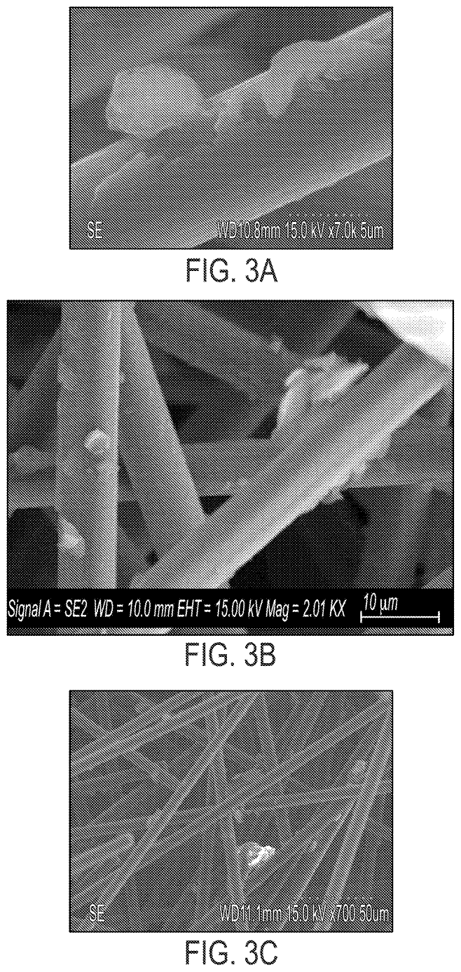

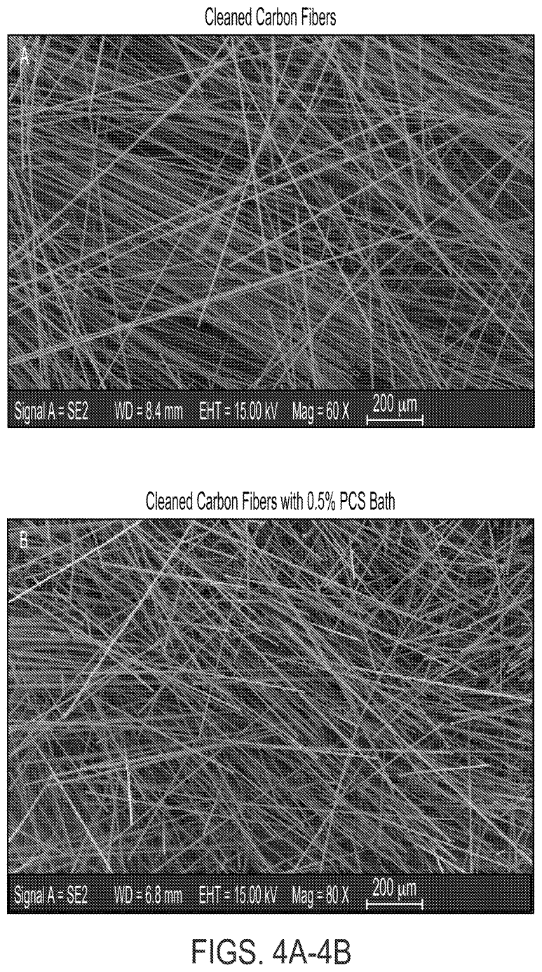

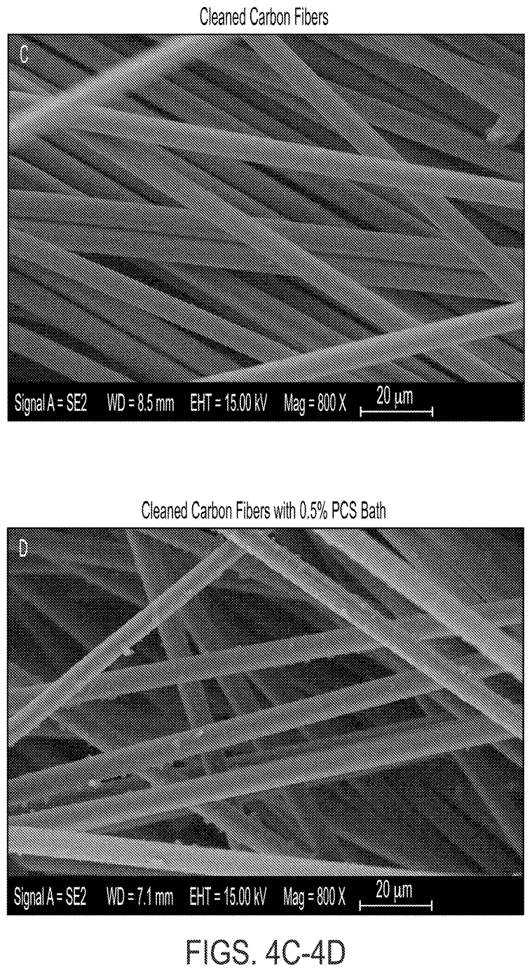

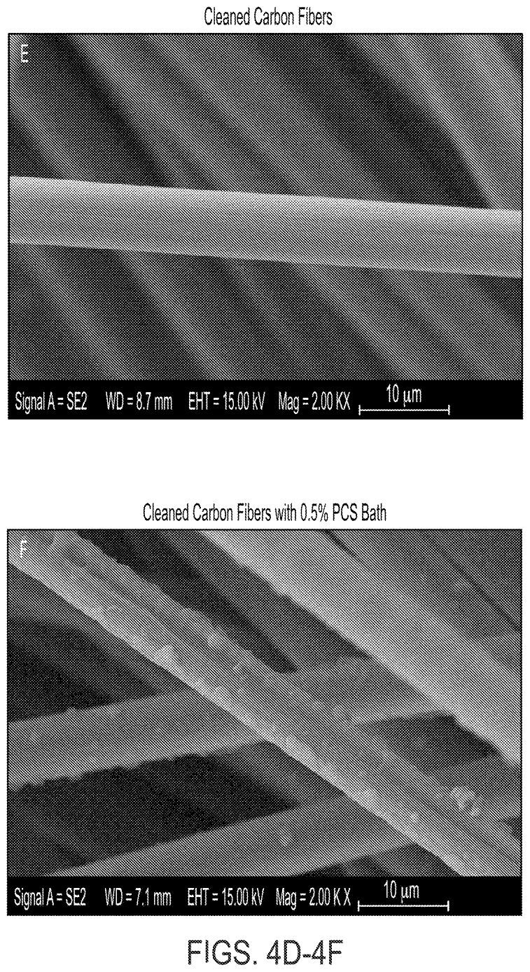

After drying in a vacuum chamber at 25° C., the fibers were analyzed using SEM. Through visual inspection under magnification, it was observed that the fibers had a thin film coating on the carbon fiber. The resulting SEM images are provided in FIGS. 3A, 3B, and 3C, which correspond to magnification of 7K×, 2×, and 700×, respectively. FIG. 4 shows SEM images for both untreated Teijin Tenax chopped fibers, and PCS-coated chopped fibers.

### The Coating Process

Current experiments were performed at room temperature with a 5:1 by wt. ratio of CF:PCS in an acetone bath. Coating process variables such as temperature, inert atmospheres, addition of oxidizing agents, varying materials ratios and the like can be adjusted to provide a more optimized coating of the fiber. These coated fibers were incorporated into a composite matrix to create fiber reinforced materials.

The coating process is described in the steps below:
In the first step, 25 grams of raw chopped carbon fibers were added to a 4 liter reaction flask.
1 Liter of acetone was then added to the reaction flask.
In the next step, 5 grams of PCS were added to the acetone/carbon fiber mixture. The PCS dissolved into the organic solvent.
The combined contents of the reaction flask were stirred for 24 hours at room temperature in a sealed reaction flask.
The fibers were filtered from the liquid media and rinsed with isopropanol followed by deionized water to remove any loose PCS and other debris.
The fibers were analyzed under SEM, the images shown in FIGS. 3A, 3B, and 3C were taken.

It was surprising that simply stirring dissolved PCS with raw carbon fiber in an organic solvent resulted in the polymer coating. The fact that no heat or other reactants were required to stimulate the reaction between the materials seems to indicate the strong affinity that PCS has for the carbon fiber surface.

### Example 3: Carbon Fiber as High-Performance Fiber

The objective of this experiment is to test the efficacy/performance of poly(catechol-styrene) (PCS) coated carbon fibers. Very thin coatings (or sizing) of PCS on carbon fibers enhances the interfacial adhesion between the fiber and resins used in reinforced plastic composites and increases the interfacial sheer strength (IFSS). This is the case with both thermoset and thermoplastic resin systems. Further the improvement in fiber/resin interfacial adhesion leads to improved material properties of the resulting composite materials such as increased flexural strength/modulus, and increased compression strength/modulus.

| Type of | | |
|---|---|---|
| Fiber | Category of Fiber | Purchased |
| Carbon | Virgin carbon fiber | Teijin Tenax |
| Carbon | Recycled carbon fiber | R&M International |
| | | Sales, Fort Wash. PA |

The carbon fibers that are coated with the catechol-containing material such as PCS are then used in the following matrices to prepare the fiber-reinforced composites.

TABLE 2

| Types of matrix | Thermoset or |
|---|---|
| materials | Thermoplastic |
| Epoxy | Thermoset |
| Hardened Epoxy | Thermoset |
| Polyester | Thermoset |
| Polyurethane | Thermoset |
| Polyimide | Thermoset |
| Phenolic | Thermoset |
| Cyanic ester | Thermoset |
| Bismaleimide | Thermoset |
| Polyethylene | Thermoplastic |
| PEEK and polyarylether- | Thermoplastic |
| ketones (PAEK) | |
| Polypropylene | Thermoplastic |
| Nylon | Thermoplastic |
| Teflon | Thermoplastic |
| Polyetherimide | Thermoplastic |
| Polybenzimidazole | Thermoplastic |
| Polyurethane | Thermoplastic |
| Polyester | Thermoset or |
| | Thermoplastic |
| Epoxy | Thermoset |
| Hardened Epoxy | Thermoset |
| Polyester | Thermoset and |
| | Thermoplastic |
| Polyurethane | Thermoset |
| Polyimide | Thermoset |
| Phenolic | Thermoset |
| Cyanic ester | Thermoset |
| Bismaleimide | Thermoset |
| Polyethylene | Thermoplastic |
| PEEK | Thermoplastic |
| Polypropylene | Thermoplastic |
| Nylon | Thermoplastic |
| Teflon | Thermoplastic |
| Polyetherimide | Thermoplastic |

The Ecodyst system was used for large batch coating of carbon fibers. The first fibers to be coated were recycled chopped carbon fiber from R&M. About 18 liters of acetone was added to the Ecodyst along with 90 g of PCS, for this coating PCS32 was used with a Mw of 150,000 g/mol. The PCS was dissolved fully into the acetone before 250 g of carbon fibers were added. The carbon fibers were then stirred for 1 hour, afterwards the PCS solution was drained and collected for future batches. The carbon fibers were then spread out on a large cookie sheet and placed under the fume hood overnight to dry and remove any excess acetone. This process was repeated until 2 kg of carbon fibers were coated, changing the PCS solution entirely after 1 kg of carbon fibers were coated.

In FIG. 4 carbon fibers coated with PCS are shown. SEM micrographs of carbon fibers without any coating treatment (FIGS. 4A, 4C, 4E) or with a PCS coating (FIGS. 4B, 4D, 4F). In FIGS. 4A, 4C and 4E, carbon fibers have been cleaned with a one-hour acetone bath. FIGS. 4B, 4D and 4F depict a portion of the cleaned carbon fibers that were stirred in a 0.5% PCS bath for one hour. The PCS coated fibers were then washed with 1× phosphate buffer saline and then isopropanol to remove any unbound PCS from the fibers. In FIG. 4F, PCS can be seen adhering to and coating individual carbon fibers. FIGS. 4C and 4E are magnified views at 800× and 2K×, respectively, of FIG. 4A at 50×. FIGS. 4D and 4F are magnified views at 800× and 2K×, respectively, of FIG. 4B at 60×. Scale bars of FIGS. 4A and 4B are 200 microns, FIGS. 4C, 4D are 20 microns, and FIGS. 4E, 4F are 10 microns.

### Example 4: Recycled Carbon Fiber as High-Performance Fiber

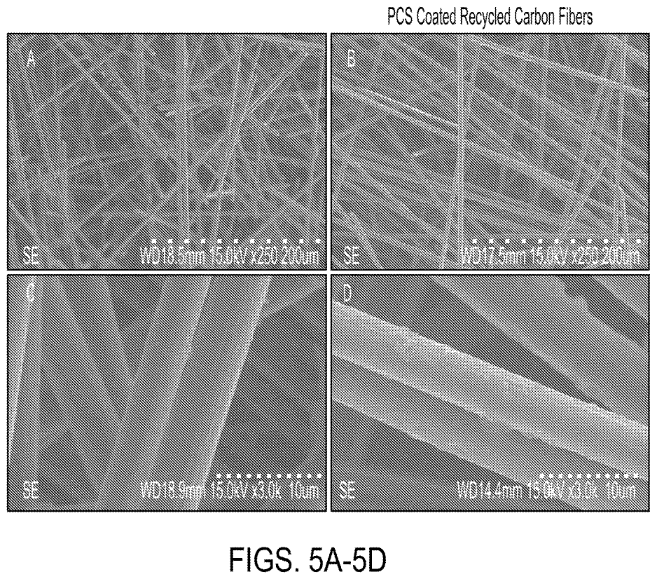

Recycled Carbon fibers are coated with PCS. SEM micrographs of recycled carbon fibers are provided in FIG. 5. (FIGS. 5A, 5C) are recycled carbon fibers that have been cleaned with acetone; there appeared to be a residual coating left on the fibers which could be possibly epoxy. FIGS. 5B and 5D depict recycled carbon fibers that have been treated with a poly(catechol-styrene) (PCS) coating. The PCS coated fibers appeared to have a thicker and more pronounced coating than the residual coating on the recycled carbon fibers. The fibers were cleaned in an acetone bath, stirred in a 0.5% PCS solution for 1 hour, then rinsed with an isopropyl alcohol bath to remove any unbound PCS. FIGS. 5C and 5D are magnified views at 3K× of FIGS. 5A and 5B at 250×, respectively. Scale bars of FIGS. 5A and 5B are 200 microns, and FIGS. 5C and 5D are 10 microns.

Further, it has been shown that the fiber coating thickness can be adjusted by varying the concentration of PCS in the coating bath. However, it has not yet been determined what the optimal coating thickness is for improvements to IFSS and improved composite performance. FIG. 2 illustrates the impact in changing the concentration of PCS in the coating bath.

### Example 5: PCS Coating Thickness is Controllable with Polymer Concentration

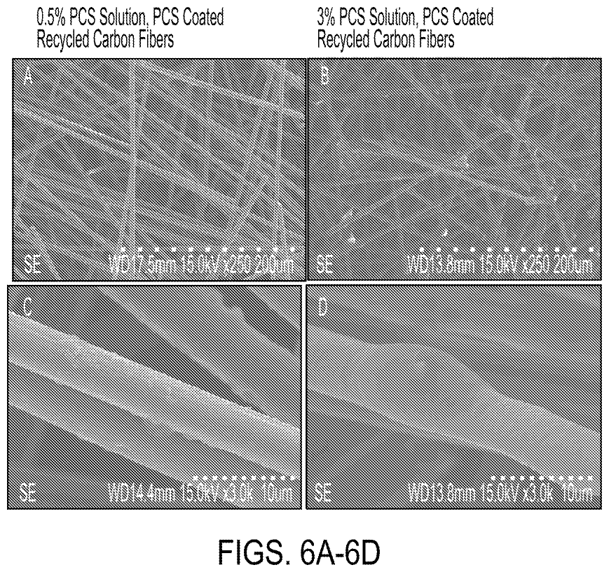

SEM micrographs of poly(catechol-styrene) (PCS) coated recycled carbon fibers are shown in FIGS. 6A-6D. For FIGS. 6A and 6C, a 0.5% PCS solution was used to coat the fibers, which provided good coverage of the fibers. For FIGS. 5B and 5D, a 3% PCS solution was used to coat the fibers, which heavily coated the fibers in a thick PCS coating. These data show that the PCS coating thickness is controllable based on the concentration of the polymer solution. The fibers were cleaned in an acetone bath, stirred in either a 0.5% or 3% PCS solution for 1 hour, then rinsed with an isopropyl alcohol bath to remove any unbound PCS. FIGS. 6C and 6D are magnified views at 3K× of FIGS. 6A and 6B at 250×, respectively. Scale bars of FIGS. 6A and 6B are 200 microns, and FIGS. 6C and 6D are 10 microns.

The fibers used herein were recycled carbon fibers that contained a significant amount (5-14%) of residual resin (believed to be epoxy). Nonetheless, it is clear that the thickness of the PCS coating changes with the concentration of polymer in the coating bath. It is also important to note that the PCS concentration numbers (0.5% and 3%) are the wt. % of PCS in the acetone bath, and not the resulting wt. % of the coating added to the carbon fiber.

### Example 6: Poly(Catechol-Styrene) as a Sizing Agent for Carbon Fiber Reinforced Composites

In this example, PCS is used as a carbon fiber sizing agent to the performance of composite material properties. The performance of the PCS sizing agent varies between resin systems. Epoxy resin system is used for this testing. Dip coating is used to coat carbon fiber tows and fabrics with PCS. The PCS sizing thickness and its concentration by weight to the carbon fiber materials (while varying the dipping bath concentration) is quantified. Laminates are constructed from PCS-sized tows and/or fabrics. The impact of PCS sizing on composite materials properties are evaluated: tensile strength/modulus; flexural strength/modulus; and compression strength/modulus. The performance of the composite materials constructed with the PCS sizing is compared to composites constructed using both as-received fabrics (sizing provided) and de-sized fabrics. This allows for a clear evaluation of the impact of the PCS sizing on the composite properties. Dip-coating is used to prepare PCS sized carbon fiber fabrics and tows. Because PCS is not water soluble, a suitable solvent is selected for the coating process. For example, acetone is used for coating applications. The dip-coating process is optimized to control the PCS sizing addition, which is controlled by PCS concentration in the coating bath and the residence time of the fiber in the coating solution.

Three different “levels” of PCS sizing addition (for example 0.5%, 1%, and 1.5% mass addition of PCS to the fiber material) are selected. Using the various sized carbon fiber fabrics, multi-ply laminates are fabricated for the purposes of material properties testing. Laminates are also fabricated using the fabric-as-received (with standard sizing) and also unsized fabric for the purpose of experimental controls. An appropriate epoxy resin to be used across all composite samples. Following fabrication, panels are cut to produce the test samples for testing.

For the test samples, the following material properties are evaluated:
Tensile Strength and Modulus
Flexural Strength and Modulus
Compression Strength and Modulus

Material properties data from the PCS sized samples are compared to the control samples to evaluate the impact on overall material properties.

To test the increased laminate bonding strength lap shear tests are run on the composite laminate bonded with epoxy 250° F. cure adhesive. The tests are run for samples that are baseline with no surface prep and samples with surface prep. Samples are also prepared with 1% additive brushed on to surface with no prep and prep. In one test, a rubber sheet material is bonded onto the bismaleimide laminate surface with various adhesives at elevated temperature and room temperature. Peel strength is measured. In one evaluation a paint adhesion test of polyetheretherketone (PEEK) laminate is performed.

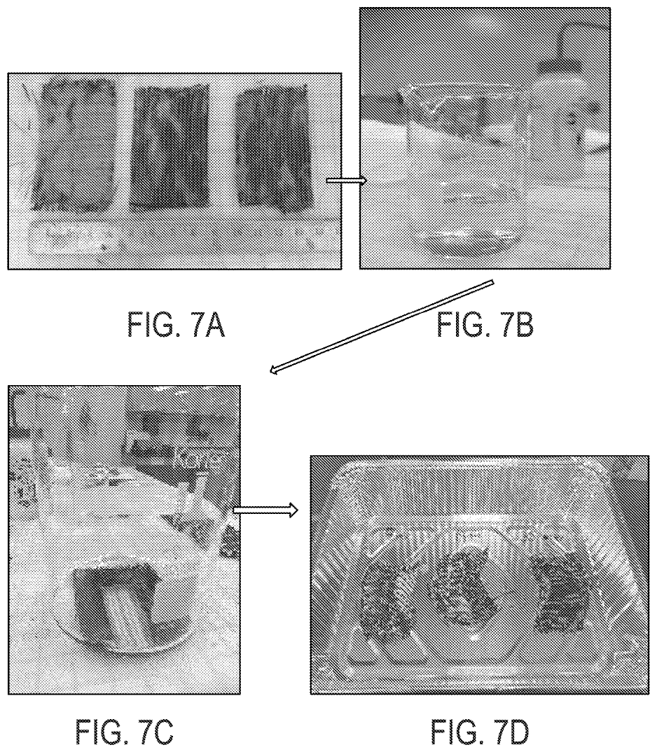

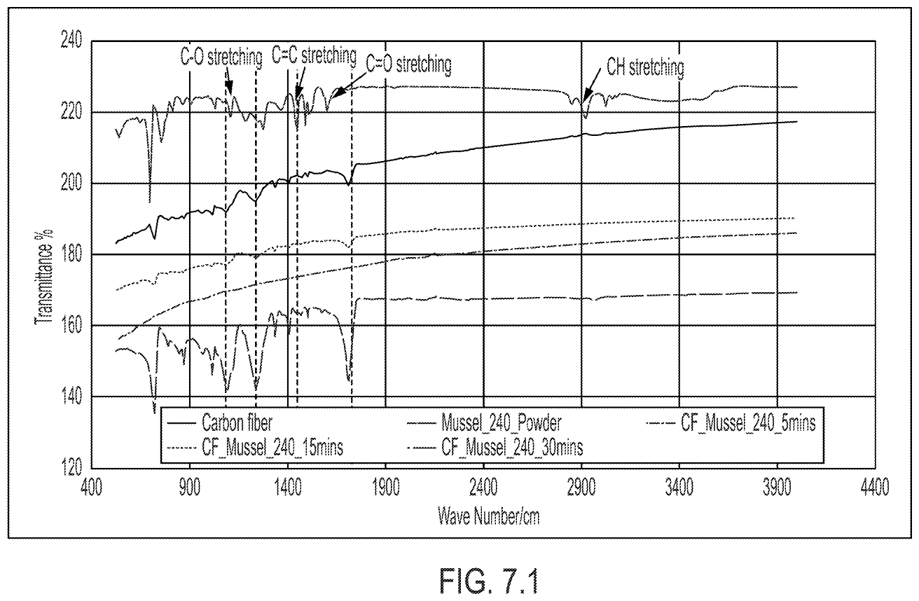

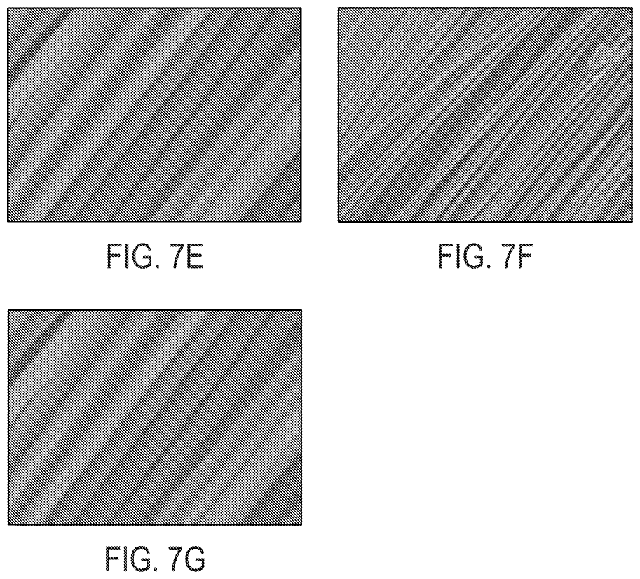

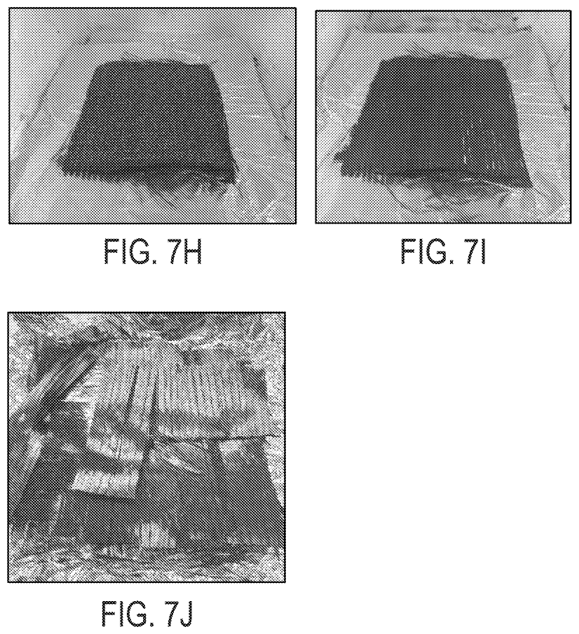

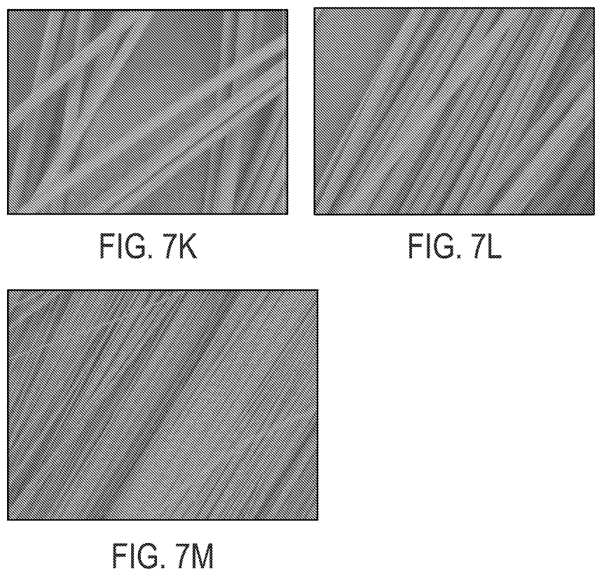

Two samples polycatechol styrene are used for sizing of carbon fibers. The first sample has a molecular weight of 240K Dalton and the second sample has a molecular weight of 110K Daltons. Carbon fiber used is laid up in a 0°/90° biaxial orientation. Sized and unsized fibers are pre-formed. Dip-coating solution of PCS is made in acetone at 0.5%, 1.0%, 1.5% and 2% concentrations by weight. A composite panel is made from the sized and unsized fibers. Chomarat® carbon fiber (0/90) (Chomarat North America, SC) in a two-layer configuration is used. The carbon fiber (FIG. 7A) is dipped in the solutions (FIGS. 7B and 7C), for example, 0.5 g of polymer in 99.5 g of acetone for 5 min, 15 min, and 30 min. The samples are air-dried for 24 hours (FIG. 7D).

MP peaks are seen after 30 min dip-coating treatment. OH stretching is not detected around 3300-3400 cm⁻¹ wave number. See Table 3 below and FIG. 7.1:

| Wavenumber (cm⁻¹) | Structure |
|---|---|
| 3300-3400 | OH stretching |
| 2900-2950 | CH stretching |
| 1700-1800 | C═O stretching |
| 1600-1650 | C═C stretching |
| 1100-1150 | C—C stretching |

FIGS. 7E, 7F, and 7G show as-received Chomarat® carbon fiber (0/90) that are two layers at three different magnifications. These fibers are without treatment and before burn-off, some sizing is seen in the SEMs. To remove the sizing that is already present in the as received carbon fibers, they are burned off in a furnace at 400° C. for one hour. FIG. 7H shows the carbon fibers before burn-off, and FIGS. 7I and 7J are carbon fibers after burn-off. FIGS. 7K, 7L, and 7M are SEM micrographs of the carbon fiber after the furnace burn-off. The carbon fibers as can be seen are now unsized.

FTIR is performed using ThermoScientific Nicolet iS50 FT-IR Spectrometer (which measures the absorption spectrum in the mid-IR region (5000-400 cm⁻¹)) on carbon fiber, on the 240K polymer sample, and on the carbon fiber with the 240K polymer coated on it as sizing. The infrared spectra region was 4000-400 cm⁻¹ and the number of scans was 64.

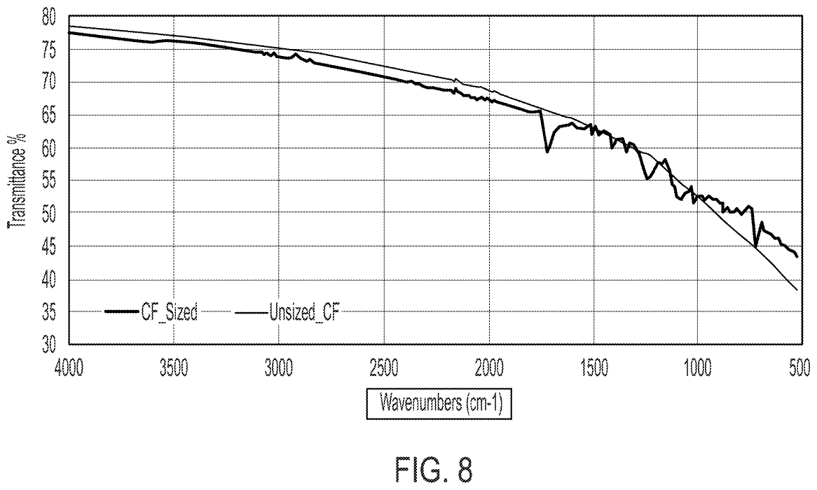

FIG. 8 shows the FTIR scan for the as-received and burnt-off carbon fibers. Both the as-received and unsized carbon fibers are dip-coated with the 240K PCS solution in acetone.

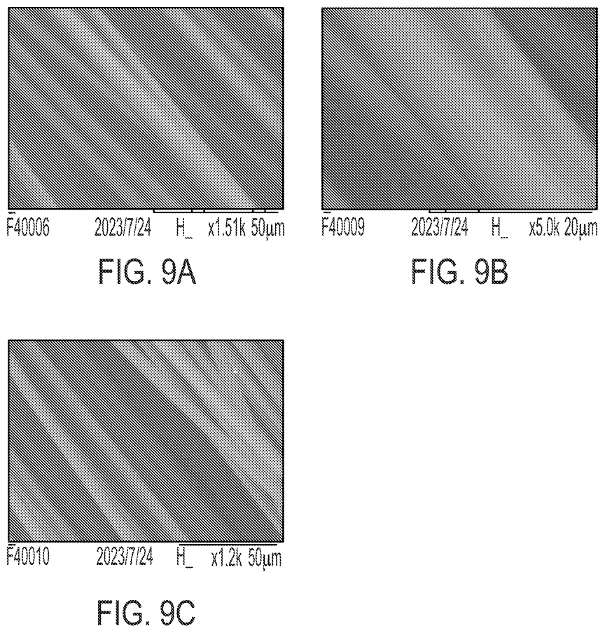

FIGS. 9A, 9B, and 9C are SEMs of the as-received carbon fiber that is coated with a 0.5% PCS polymer solution in acetone that is dip-coated for 30 min.

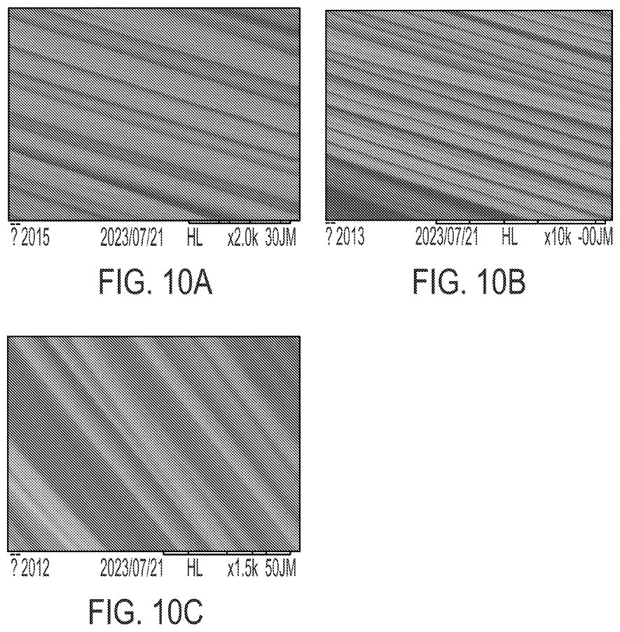

FIGS. 10A, 10B, and 10C are SEMs of the as-received carbon fiber that is coated with a 1.0% PCS polymer solution in acetone that is dip-coated for 30 min.

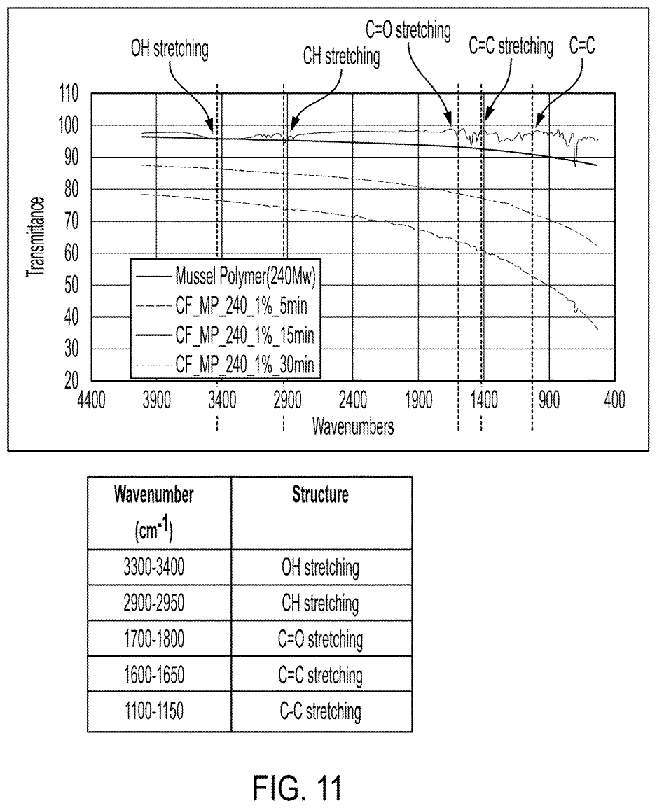

FIG. 11 shows the FTIR scan for the as-received carbon fibers that were coated with 1% PCS in an acetone solvent with the dip-coating of 5, 15, and 30 min. The PCS used is the 240K Dalton molecular-weight material.

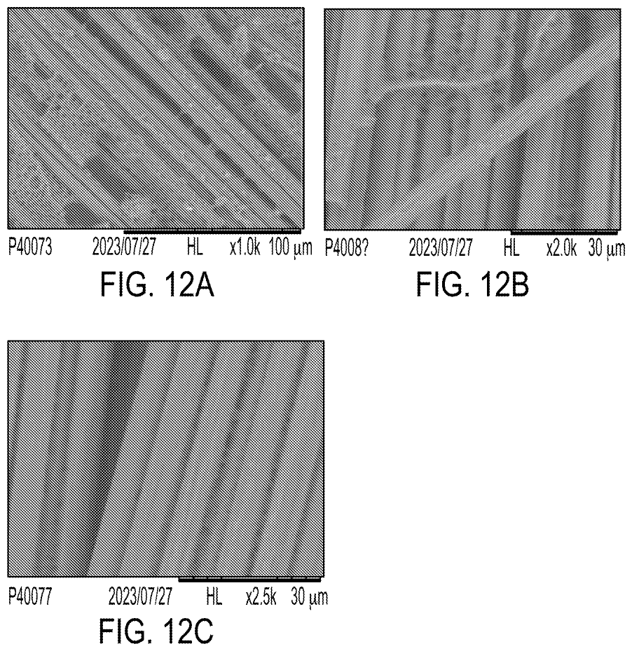

FIGS. 12A, 12B, and 12C are SEMs of the as-received carbon fiber that is coated with a 1.5% PCS polymer solution in acetone that is dip-coated for 5 min.

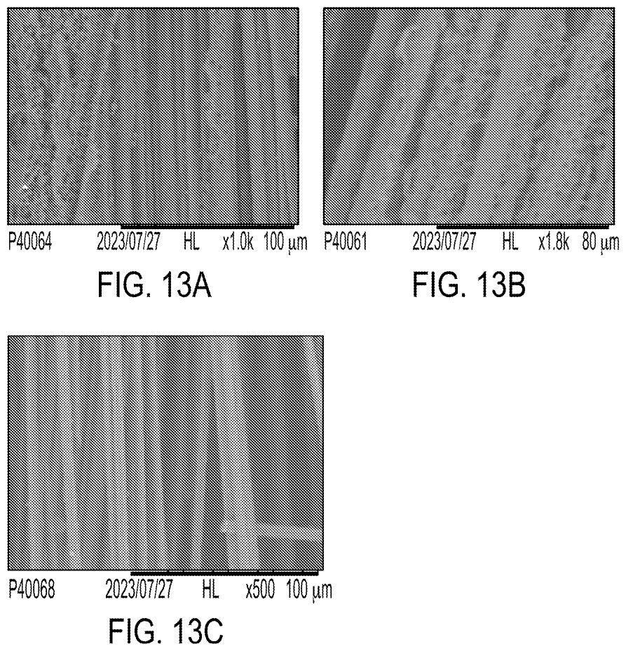

FIGS. 13A, 13B, and 13C are SEMs of the as-received carbon fiber that is coated with a 1.5% PCS polymer solution in acetone that is dip-coated for 15 min.

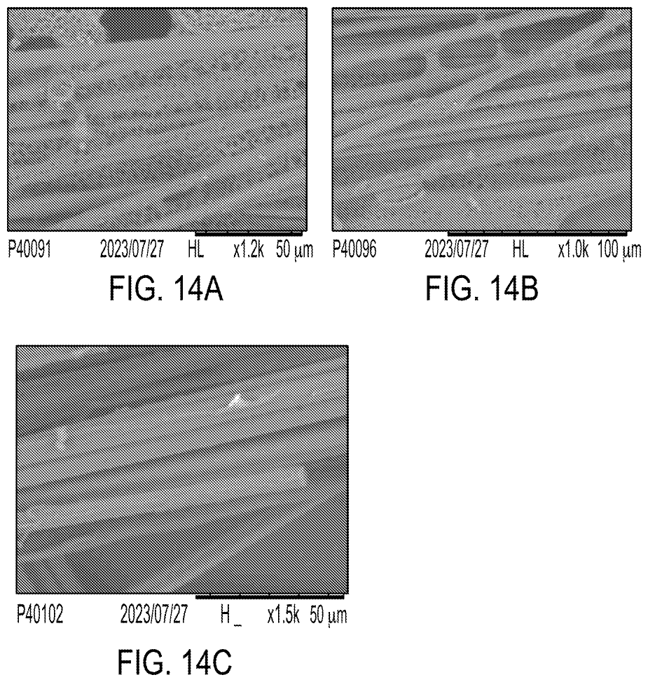

FIGS. 14A, 14B, and 14C are SEMs of the as-received carbon fiber that is coated with a 1.5% PCS polymer solution in acetone that is dip-coated for 30 min.

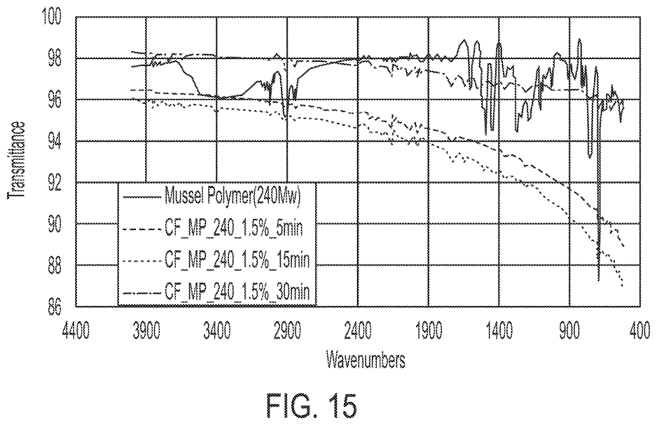

FIG. 15 shows the FTIR scan for the as-received carbon fibers that were coated with 1.5% PCS in an acetone solvent with the dip-coating of 5, 15, and 30 min. The PCS used is the 240K Dalton molecular-weight material.

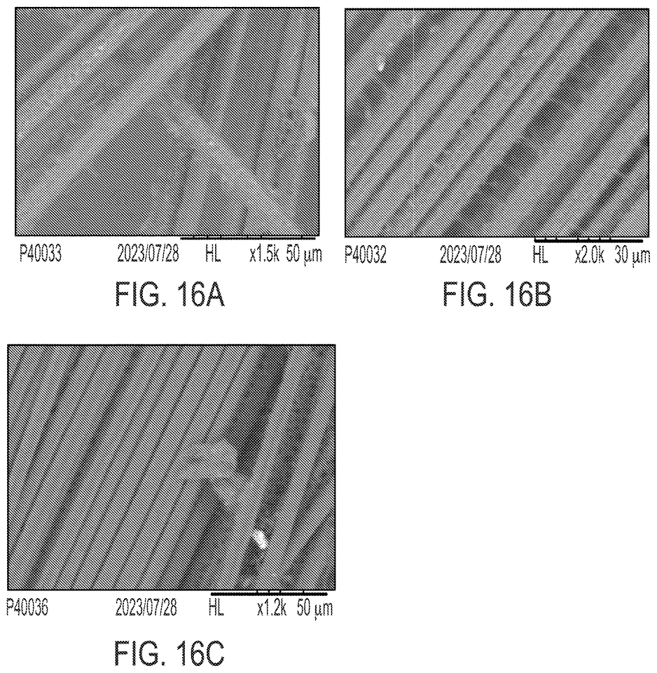

FIGS. 16A, 16B, and 16C are SEMs of the as-received carbon fiber that is coated with a 2.0% PCS polymer solution in acetone that is dip-coated for 5 min.

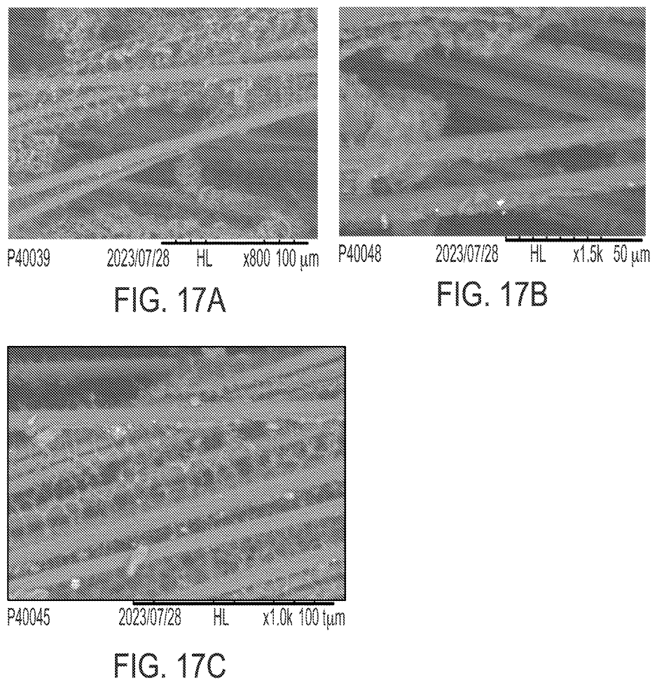

FIGS. 17A, 17B, and 17C are SEMs of the as-received carbon fiber that is coated with a 2.0% PCS polymer solution in acetone that is dip-coated for 15 min.

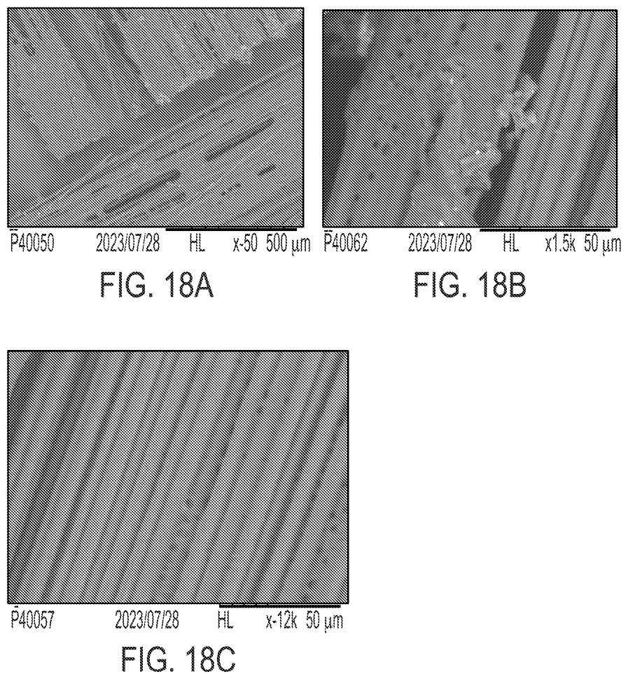

FIGS. 18A, 18B, and 18C are SEMs of the as-received carbon fiber that is coated with a 2.0% PCS polymer solution in acetone that is dip-coated for 30 min.

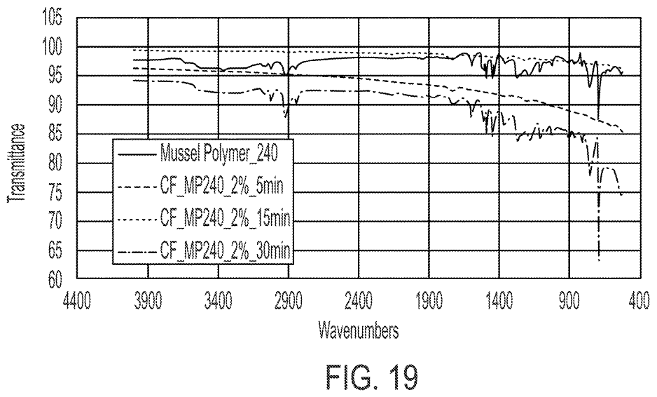

FIG. 19 shows the FTIR scan for the as-received carbon fibers that were coated with 2.0% PCS in an acetone solvent with the dip-coating of 5, 15, and 30 min. The PCS used is the 240K Dalton molecular-weight material.

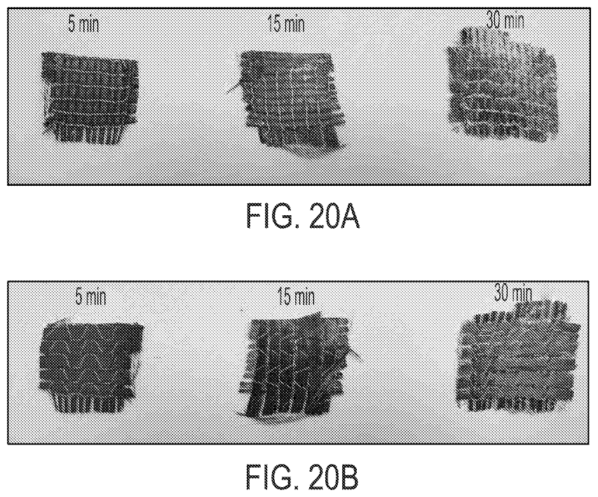

FIG. 20A shows the top surface of the carbon fiber after dip-coating at 5, 15, and 30 min. FIG. 20B shows the bottom surface of the carbon fiber after dip-coating at 5, 15, and 30 min.

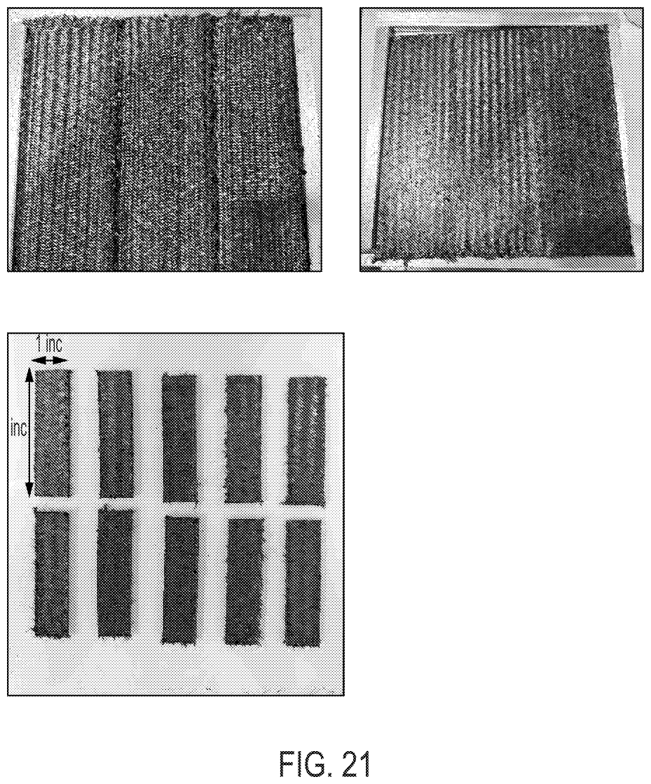

FIG. 21 shows the carbon fiber that has been sized with PCS via dip-coating that is then used to make a laminate with PEEK matrix.

It was seen that the distinct peaks and sizing were observed on CF (as received) for 1.5 wt. % and 2 wt. % dip coating using the 240K Dalton PCS in acetone.

In a similar manner unsized carbon fibers (as-received that are burned-off) are also coated with a 0.5, 1.0, 1.5, and 2.0% PCS solution in acetone. Both molecular weight PCS are used to form the dip-coating solution.

1. A coated high-performance fiber (HPF) coated with a catechol-containing material on the HPF, comprising a polymer containing catechol, semi-quinone, or quinone.

2. The coated HPF as recited in claim 1, wherein the catechol-containing material coated on the HPF comprises monomeric, oligomeric, or polymeric catechol or catechol-containing material, wherein said catechol presents as a catechol and/or as a semi-quinone and/or as a quinone without the presence of an amine; and wherein the polymeric layer optionally comprises at least one of: a) a reactive species separate from the catechol or catechol-containing material; and b) a catalyst, co-catalyst or an accelerator.

3. The coated HPF of claim 1, wherein the polymeric material comprises the reactive species separate from the catechol-containing polymer or oligomer; and the reactive species is a urethane component, an epoxy resin, an acrylate monomer or oligomer, a methacrylate monomer or oligomer, a silane, or a combination thereof

4. The coated HPF of claim 3, wherein the reactive species is:
(i) a urethane component;
(ii) a urethane component that is a polyol or an organic compound containing multiple hydroxyl groups, and wherein the urethane is linear or branched;
(iii) a urethane component that is 1,6-hexanediol, glycerol, Stepanpol PDC-279® or poly caprolactone triol;
(iv) an epoxy resin;
(v) an epoxy resin that is an epoxy monomer, an epoxy oligomer, a poly epoxide or combinations thereof; and wherein the epoxy is linear or branched;
(vi) an epoxy resin that is bisphenol A diglycidyl ether, Bisphenol A epoxy resin, bis(4-glycidyloxyphenyl)methane, bisphenol E diglycidyl ether (DGEBE), 2,2′-[I,I-Ethanediylbis(4,I-phenyleneoxymethylene)]dioxirane, bisphenol F diglycidyl ether (DGEBF), poly(bisphenol A-co-epichlorohydrin) or combinations thereof;
(vii) an acrylate monomer or oligomer;
(viii) an acrylate monomer or oligomer that is an acrylate monomer comprising a vinyl group and at least one of a carboxylic acid ester and a carboxylic acid nitrile; and wherein the acrylate is linear or branched; or
(ix) an acrylate monomer or oligomer that is ethyl acrylate, ethylene-methyl acrylate, methyl methacrylate, 2-chloroethyl vinyl ether, 2-hydroxyethyl acrylate, hydroxyethyl methacrylate, butyl acrylate, trimethylolpropane triacrylate (TMPTA) or combinations thereof.

5. The coated HPF of any one of the preceding claims, wherein the polymeric layer comprises the catalyst, co-catalyst or accelerator; and the catalyst, co-catalyst or accelerator is a urethane catalyst that promotes a urethane polymerization reaction, an epoxy catalyst that promotes an epoxy polymerization reaction, an acrylate catalyst that promotes an acrylate polymerization reaction, or combinations thereof.

6. The coated HPF of claim 5, wherein the catalyst, co-catalyst or accelerator is:
(i) a urethane catalyst that promotes a urethane polymerization reaction;
(ii) a urethane catalyst that promotes a urethane polymerization reaction that is 1,4-diazabicyclo[2.2.2]octane, K-KAT 6212, benzyldimethylamine or combinations thereof;
(iii) an epoxy catalyst that promotes epoxy polymerization;
(iv) an epoxy catalyst that is 1,4-diazabicyclo[2.2.2]octane;
(v) an acrylate catalyst that promotes acrylate polymerization; or
(vi) an acrylate catalyst that is an acrylic or a free-radical polymerization promoter.

7. The coated HPF of any one of the preceding claims, wherein the coating of the polymeric material has a thickness:
(i) of from about 5 nanometers to about 100 microns;
(ii) of from about 15 nanometers to about 50 microns;
(iii) of from about 15 nanometers to about 15 microns;
(iv) of from about 50 nanometers to less than about 15 microns; or
(v) of from about 50 nanometers to about 1.5 microns.

8. The coated HPF of any one of the preceding claims, wherein the catechol-containing polymer or oligomer comprises poly-catechol styrene (PCS).

9. The coated HPF of any one of the preceding claims, wherein the molecular weight is in the range of 100 to 1000,000.

10. The coated HPF of claim 8, wherein the PCS comprises from about 15% catechol to about 85% catechol.

11. The coated HPF of claim 10, wherein the PCS comprises about 25% catechol or about 35% catechol.

12. The coated HPF of any one of the preceding claims, wherein the HPF is a polymer.

13. The coated HPF of any one of the preceding claims, wherein the HPF is an aramid, a super-aramid, an aramid copolymer, a meta-aramid, an LCP, the UHMWPE polymer, a polyamide, a polyester, a polyolefin, or a combination thereof.

14. A fiber-reinforced composite comprising one or more HPF of claim 13.

15. A coated high-performance fiber (HPF) as recited in claims 1-11, wherein the HPF is a carbon fiber.

16. A fiber-reinforced composite comprising the HPF fibers of claim 15.

17. A fiber-reinforced composite as recited in claim 14 or 16, wherein the matrix polymer is selected from:
Polypropylene, Polyethylene, Polycarbonate, Polyvinyl Chloride, Polyetheretherketone, Polyethersulfone, Polyphenylene Sulfide, Polyamide, Polymethyl Methacrylate, Polyetherimide, Acetal, Sulfone Polymers, Ethylene-Vinyl Acetate, Liquid Crystal Polymers, Polybutylene Terephthalate, Acrylonitrile Butadiene Styrene, Fluoropolymers, Thermoplastic Elastomers, Thermoplastic Polyurethane, Polycyclohexylenedimethylene Terephthalate, Epoxy Resins, Polyester Resins, Vinyl Ester Resins, Phenolic Resins, Polyimides, Polyurethane, Polystyrene, Silicone Resins, Cyanate Esters, Melamine-Formaldehyde Resins, Polydicyclopentadiene, Polyarylate, Polybenzimidazole, Polychlorotrifluoroethylene, Methyl Methacrylate-Butadiene-Styrene, Polyacrylonitrile, Polyhydroxyalkanoates, Polylactic Acid, Polyhydroxybutarate, Polyoxymethylene copolymer.

18. A method for preparing the HPF as recited in claim 13 or 15, said method comprising exposing HPF to pre-polymerized catechol-containing polymers dissolved in one or more solvents.

19. A method for functionalizing the surface of the HPF surface as recited in claim 13 or 15, comprising exposing the HPF to pre-polymerized catechol-containing polymers dissolved in one or more solvents.

20. The coated HPF as recited in claim 13 or 15, wherein the HPF are fully or partially covered with material comprising PCS polymer.

21. An article of manufacture comprising a fiber reinforced composite as recited in claim 13 or 15.

22. A method for applying a coating to at least one face of a substrate made of fiber-reinforced composite as recited in claim 14 or 16, wherein the method comprises:
applying a PCS layer filled with particles of graphene or of zinc to the at least one face of the substrate as a primer, and
applying a coating to the zinc or graphene particle-filled PCS layer.

23. The method as recited in claim 21, wherein:
the zinc or graphene particle-filled adhesive PCS layer has a thickness of between 200 nm and 100 μm; and/or
the PCS layer is filled with graphene particles and comprises 0.5% to 2% by weight of graphene.

24. A substrate comprising, on at least one face a coating applied by implementing a method as claimed 21 or 22.

25. An aircraft part comprising the substrate as recited in claim 23.
